(19) United States
(12) Patent Application Publication
(10) Pub. No.: US 2026/0006618 A1
(43) Pub. Date: Jan. 1, 2026

(54) COMMUNICATION SCHEDULING FOR REDUCED THROUGHPUT IN WIDEBAND

(71) Applicant: QUALCOMM Incorporated, San Diego, CA (US)

(72) Inventors: Diana MAAMARI, San Diego, CA (US); Gabi SARKIS, San Diego, CA (US); Le LIU, San Jose, CA (US); Kangqi LIU, San Diego, CA (US); Weimin DUAN, San Diego, CA (US)

(21) Appl. No.: 18/756,308

(22) Filed: Jun. 27, 2024

(51) Int. Cl. H04W 72/231; H04W 16/28; H04W 72/0446; H04W 72/51

(52) U.S. Cl. CPC H04W 72/231; H04W 16/28; H04W 72/0446; H04W 72/51

(57) ABSTRACT

Methods, systems, and devices for wireless communications are described. A user equipment (UE) may receive a downlink control information (DCI) information scheduling multiple transmissions, where at least one of the transmissions is processed according to a reduced threshold throughput in wideband. For example, the UE may receive the DCI message scheduling two or more transmissions, where the DCI message is indicative that at least one transmission of the two or more transmissions is to be processed in accordance with the first threshold throughput. The first threshold throughput may be less than a second threshold throughput configured at the UE. For example, the first threshold throughput may be associated with wideband processing, and the second threshold throughput may be associated with narrowband processing. The UE may receive the at least one transmission based on the DCI message and process the at least one transmission in accordance with the first threshold throughput.

### FIELD OF TECHNOLOGY

The following relates to wireless communications, including communication scheduling for reduced throughput in wideband.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). A UE may receive a downlink control information (DCI) message scheduling multiple transmissions, such as multiple physical downlink shared channel (PDSCH) messages. Additionally, the UE may operate in one or more operation modes associated with different processing parameters. For example, the UE may process transmissions from the network entity according to different threshold throughputs associated with the operation modes.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a DCI message scheduling two or more transmissions, where the downlink control information (DCI) message is indicative that at least one transmission of the two or more transmissions is to be processed in accordance with a first threshold throughput, where the first threshold throughput is less than a second threshold throughput configured at the UE and receiving, based on the DCI message, the at least one transmission, where the at least one transmission is processed in accordance with the first threshold throughput.

A UE for wireless communications is described. The UE may include one or more memories storing processor executable code, and one or more processors coupled with the one or more memories. The one or more processors may individually or collectively be operable to execute the code to cause the UE to receive a DCI message scheduling two or more transmissions, where the DCI message is indicative that at least one transmission of the two or more transmissions is to be processed in accordance with a first threshold throughput, where the first threshold throughput is less than a second threshold throughput configured at the UE and receive, based on the DCI message, the at least one transmission, where the at least one transmission is processed in accordance with the first threshold throughput.

Another UE for wireless communications is described. The UE may include means for receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE and means for receiving, based on the DCI message, the at least one transmission, where the at least one transmission is processed in accordance with the first threshold throughput.

A non-transitory computer-readable medium storing code for wireless communications is described. The code may include instructions executable by one or more processors to receive a DCI message scheduling two or more transmissions, where the DCI message is indicative that at least one transmission of the two or more transmissions is to be processed in accordance with a first threshold throughput, where the first threshold throughput is less than a second threshold throughput configured at the UE and receive, based on the DCI message, the at least one transmission, where the at least one transmission is processed in accordance with the first threshold throughput.

In some examples of the method, UEs, and non-transitory computer-readable medium described herein, the DCI message may be indicative that the two or more transmissions are to be processed in accordance with the first threshold throughput.

In some examples of the method, UEs, and non-transitory computer-readable medium described herein, receiving the DCI message may include operations, features, means, or instructions for receiving, in the DCI message, one or more DCI fields indicative that the at least one transmission are to be processed in accordance with the first threshold throughput.

In some examples of the method, UEs, and non-transitory computer-readable medium described herein, the one or more DCI fields correspond to respective transport blocks of the two or more transmissions scheduled by the DCI message.

In some examples of the method, UEs, and non-transitory computer-readable medium described herein, the one or more DCI fields correspond to the two or more transmissions scheduled by the DCI message.

Some examples of the method, UEs, and non-transitory computer-readable medium described herein may further include operations, features, means, or instructions for transmitting a capability message indicative of a capability of the UE associated with processing and receiving control signaling, responsive to the capability message, that may be indicative of a scaling factor, where the first threshold throughput may be based on the scaling factor.

In some examples of the method, UEs, and non-transitory computer-readable medium described herein, receiving the DCI message may include operations, features, means, or instructions for receiving, in the DCI message, an indication of a row of a time domain resource allocation (TDRA) table at the UE, where the row of the TDRA table may be indicative of the first threshold throughput and a slot offset between the DCI message and the at least one transmission of the two or more transmissions.

Some examples of the method, UEs, and non-transitory computer-readable medium described herein may further include operations, features, means, or instructions for determining to process the at least one transmission of the two or more transmissions in accordance with the first threshold throughput based on one or more gaps between respective resource allocations associated with the two or more transmissions.

Some examples of the method, UEs, and non-transitory computer-readable medium described herein may further include operations, features, means, or instructions for transmitting one or more feedback messages indicative of whether the at least one transmission and one or more other transmissions of the two or more transmissions may be successfully decoded by the UE, where: the at least one transmission and the one or more other transmissions may be processed in accordance with the first threshold throughput, and the one or more feedback messages may be transmitted via a same set of resources or respective sets of resources.

Some examples of the method, UEs, and non-transitory computer-readable medium described herein may further include operations, features, means, or instructions for receiving control signaling indicative of a first slot offset and a second slot offset, where: the first slot offset and the second slot offset each relate to respective durations of time between the DCI message and feedback messages associated with transmissions scheduled by the DCI message, the first slot offset may be associated with the first threshold throughput, and the second slot offset may be associated with the second threshold throughput.

Some examples of the method, UEs, and non-transitory computer-readable medium described herein may further include operations, features, means, or instructions for transmitting first feedback in accordance with the first slot offset for one or more first transmissions of the two or more transmissions scheduled by the DCI message, where the one or more first transmissions may be processed in accordance with the first threshold throughput and transmitting second feedback in accordance with the second slot offset for one or more second transmissions of the two or more transmissions scheduled by the DCI message, where the one or more second transmissions may be processed in accordance with the second threshold throughput.

Some examples of the method, UEs, and non-transitory computer-readable medium described herein may further include operations, features, means, or instructions for receiving the two or more transmissions scheduled by the DCI message in accordance with a beam mapping pattern, where the beam mapping pattern includes one of a cyclic beam mapping pattern or a periodic beam mapping pattern.

In some examples of the method, UEs, and non-transitory computer-readable medium described herein, the beam mapping pattern may be based on the at least one transmission of the two or more transmissions being processed in accordance with the first threshold throughput.

A method for wireless communications by a network entity is described. The method may include outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE and outputting, based on the DCI message, the two or more transmissions.

A network entity for wireless communications is described. The network entity may include one or more memories storing processor executable code, and one or more processors coupled with the one or more memories. The one or more processors may individually or collectively be operable to execute the code to cause the network entity to output a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE and output, based on the DCI message, the two or more transmissions.

Another network entity for wireless communications is described. The network entity may include means for outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE and means for outputting, based on the DCI message, the two or more transmissions.

A non-transitory computer-readable medium storing code for wireless communications is described. The code may include instructions executable by one or more processors to output a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE and output, based on the DCI message, the two or more transmissions.

In some examples of the method, network entities, and non-transitory computer-readable medium described herein, the DCI message may be indicative that the two or more transmissions are to be processed in accordance with the first threshold throughput.

In some examples of the method, network entities, and non-transitory computer-readable medium described herein, outputting the DCI message may include operations, features, means, or instructions for outputting, in the DCI message, one or more DCI fields indicative that the at least one transmission are to be processed in accordance with the first threshold throughput.

In some examples of the method, network entities, and non-transitory computer-readable medium described herein, the one or more DCI fields correspond to respective transport blocks of the two or more transmissions scheduled by the DCI message.

In some examples of the method, network entities, and non-transitory computer-readable medium described herein, the one or more DCI fields correspond to the two or more transmissions scheduled by the DCI message.

Some examples of the method, network entities, and non-transitory computer-readable medium described herein may further include operations, features, means, or instructions for obtaining a capability message indicative of a capability of the UE associated with processing and outputting control signaling, responsive to the capability message, that may be indicative of a scaling factor, where the first threshold throughput may be based on the scaling factor.

In some examples of the method, network entities, and non-transitory computer-readable medium described herein, outputting the DCI message may include operations, features, means, or instructions for outputting, in the DCI message, an indication of a row of a TDRA table at the UE, where the row of the TDRA table may be indicative of the first threshold throughput and a slot offset between the DCI message and the at least one transmission of the two or more transmissions.

Some examples of the method, network entities, and non-transitory computer-readable medium described herein may further include operations, features, means, or instructions for obtaining one or more feedback messages indicative of whether the at least one transmission and one or more other transmissions of the two or more transmissions may be successfully decoded by the UE, where: the at least one transmission and the one or more other transmissions may be processed in accordance with the first threshold throughput, and the one or more feedback messages may be transmitted via a same set of resources or respective sets of resources.

Some examples of the method, network entities, and non-transitory computer-readable medium described herein may further include operations, features, means, or instructions for outputting control signaling indicative of a first slot offset and a second slot offset, where: the first slot offset and the second slot offset each relate to respective durations of time between the DCI message and feedback messages associated with transmissions scheduled by the DCI message, the first slot offset may be associated with the first threshold throughput, and the second slot offset may be associated with the second threshold throughput.

Some examples of the method, network entities, and non-transitory computer-readable medium described herein may further include operations, features, means, or instructions for obtaining first feedback in accordance with the first slot offset for one or more first transmissions of the two or more transmissions scheduled by the DCI message, where the one or more first transmissions may be processed in accordance with the first threshold throughput and obtaining second feedback in accordance with the second slot offset for one or more second transmissions of the two or more transmissions scheduled by the DCI message, where the one or more second transmissions may be processed in accordance with the second threshold throughput.

Some examples of the method, network entities, and non-transitory computer-readable medium described herein may further include operations, features, means, or instructions for outputting the two or more transmissions scheduled by the DCI message in accordance with a beam mapping pattern, where the beam mapping pattern includes one of a cyclic beam mapping pattern or a periodic beam mapping pattern.

In some examples of the method, network entities, and non-transitory computer-readable medium described herein, the beam mapping pattern may be based on the at least one transmission of the two or more transmissions being processed in accordance with the first threshold throughput.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communication systems that support communication scheduling for reduced throughput in wideband in accordance with one or more aspects of the present disclosure.

FIGS. 3A and 3B show examples of air and baseband activity diagrams that support communication scheduling for reduced throughput in wideband in accordance with one or more aspects of the present disclosure.

FIG. 4 shows an example of a process flow that supports communication scheduling for reduced throughput in wideband in accordance with one or more aspects of the present disclosure.

FIGS. 5 and 6 show block diagrams of devices that support communication scheduling for reduced throughput in wideband in accordance with one or more aspects of the present disclosure.

FIG. 7 shows a block diagram of a communications manager that supports communication scheduling for reduced throughput in wideband in accordance with one or more aspects of the present disclosure.

FIG. 8 shows a diagram of a system including a device that supports communication scheduling for reduced throughput in wideband in accordance with one or more aspects of the present disclosure.

FIGS. 9 and 10 show block diagrams of devices that support communication scheduling for reduced throughput in wideband in accordance with one or more aspects of the present disclosure.

FIG. 11 shows a block diagram of a communications manager that supports communication scheduling for reduced throughput in wideband in accordance with one or more aspects of the present disclosure.

FIG. 12 shows a diagram of a system including a device that supports communication scheduling for reduced throughput in wideband in accordance with one or more aspects of the present disclosure.

FIGS. 13 through 16 show flowcharts illustrating methods that support communication scheduling for reduced throughput in wideband in accordance with one or more aspects of the present disclosure.

### DETAILED DESCRIPTION

In some wireless communications systems, a network entity may transmit an indication of one or more bandwidth part (BWP) configurations for communications by a user equipment (UE). The BWP configurations may be associated with different sets of communication parameters and may support different threshold (e.g., maximum) throughputs and threshold (e.g., minimum) processing timelines. For example, the UE may be configured with a first BWP configuration associated with a relatively narrow bandwidth (e.g., narrowband) and a second BWP configuration associated with a relatively wide bandwidth (e.g., wideband), where the first BWP configuration may be associated with lower threshold throughputs and increased threshold processing timelines compared to the second BWP configuration. When operating in accordance with the second BWP configuration, the UE may enter a high power state. To reduce power consumption at the UE when operating in accordance with the second BWP configuration (e.g., in wideband), the network entity may indicate that the UE is to use a reduced threshold throughput, an increased processing timeline, or both relative to the threshold throughput and processing timeline associated with the second BWP. For example, the UE may process one or more transmissions in accordance with the reduced threshold throughput, the increased processing timeline, or both, thereby reducing power consumption.

Additionally, some wireless communications may support scheduling of multiple transmissions by a downlink control information (DCI) message (e.g., a single DCI). For example, the network entity may transmit a DCI to the UE scheduling multiple physical downlink shared channel (PDSCH) messages, multiple uplink shared channel (PUSCH) messages, or both. Scheduling the multiple transmissions via the DCI message may reduce overhead associated with scheduling transmissions. To reduce the power consumption at the UE associated with processing transmissions when operating in wideband and reduce the overhead, techniques described herein may support signaling which indicates transmissions scheduled by the DCI which are to be processed at the UE in accordance with the reduced threshold throughput, the increased processing timeline, or both.

Reduced threshold throughput (e.g., UE peak throughput, peak data rate, etc.) for quantity of aggregated carriers in a band or band combination may be based on (e.g., a function of) a quantity of layers, scheduled bandwidth, resource blocks, resource block groups, resource elements, modulation, coding rate, scaling factors and overhead in a time duration (e.g., an orthogonal frequency division multiplexing (OFDM) symbol, slot, or subframe). According to techniques described herein for reduced threshold throughput (e.g., or reduced data rate), a scaling factor to the OFDM symbol, slot, or subframe duration may be applied, thereby extending the time over which the UE receives a same quantity of bits for a same bandwidth, resource blocks, resource block groups, or resource elements. In some examples, the scaling factor to the scheduled time may dilate or extend the OFDM symbol, slot, or subframe duration. During the extended OFDM symbol, slot, or subframe duration, the UE may process a downlink message scheduled according to a relaxed processing timeline. In some examples, the relaxed processing may be equivalent to an extended processing timeline of a wideband processing at peak throughput.

According to techniques described herein, the UE may receive a DCI scheduling two or more transmissions, where the DCI is indicative that at least one transmission is to be processed in accordance with a first threshold throughput. The first threshold throughput may be an example of the reduced threshold throughput, and the first threshold throughput may be less than a second threshold throughput configured at the UE. For example, the second threshold throughput may be associated with the second BWP configuration, wideband operations, or the like. The DCI may be indicative that the at least one transmission is to be processed in accordance with the first threshold throughput via a resource allocation (e.g., implicitly), one or more fields, a row in a time domain resource allocation (TDRA) table, or any combination thereof. The UE may process the at least one transmission in accordance with the first threshold throughput. For example, processing the at least one transmission in accordance with the first threshold throughput may involve processing the transmission over one or more slots after a slot in which the transmission is received (e.g., over the increased processing timeline). After processing the at least one transmission, the UE may transmit feedback based on whether the at least one transmission is successfully decoded by the UE. The feedback may be transmitted in accordance with a timeline (e.g., a slot offset) associated with the first threshold throughput, and, in some aspects, feedback for different transmissions may be transmitted via a same uplink resource (e.g., combined).

Aspects of the disclosure are initially described in the context of wireless communications systems. Aspects of the disclosure are also described in the context of exemplary air and baseband activity diagrams and process flows. Aspects of the disclosure are further illustrated by and described with reference to apparatus diagrams, system diagrams, and flowcharts that relate to communication scheduling for reduced throughput in wideband.

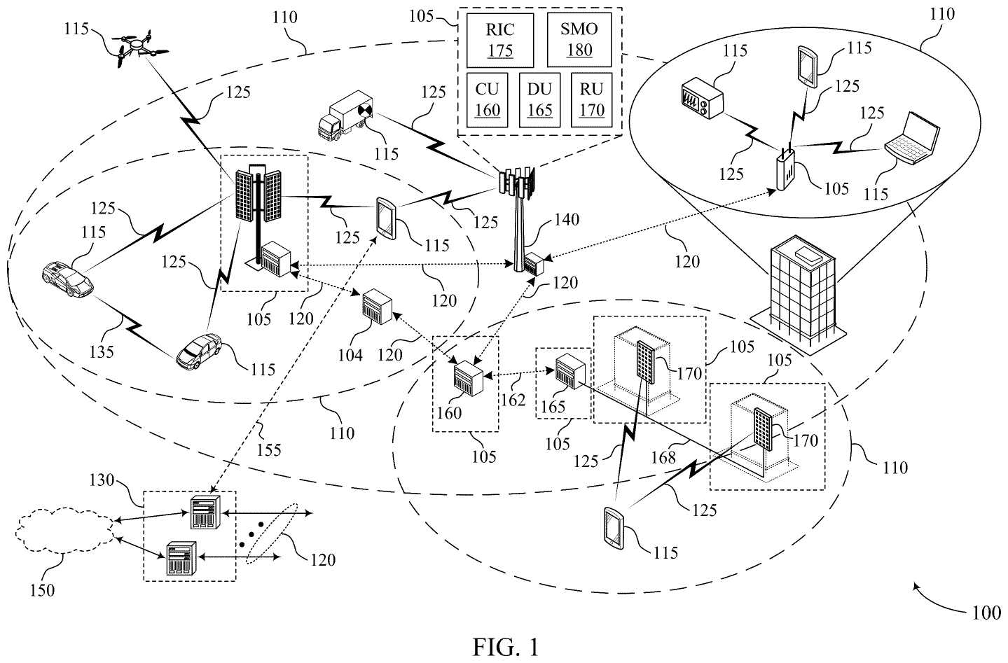

FIG. 1 shows an example of a wireless communications system 100 that supports communication scheduling for reduced throughput in wideband in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute

RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-b ands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-b ased feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, the network entity 105 may configure one or more sets of communication parameters (e.g., BWP configurations or configuration profiles) relating to downlink reception and uplink transmission by the UE 115. The sets of communication parameters may be referred to as or may represent examples of BWP configurations, configuration profiles, or any combination thereof. For example, the network entity 105 may transmit a RRC configuration message or some other type of configuration message that indicates the one or more sets of communication parameters. The configuration parameters may include a maximum bandwidth for scheduling, a maximum rank, a maximum modulation order (e.g., by configuring which MCS table is used), other parameters for communications between the UE 115 and the network entity 105, or any combination thereof. In some cases, a BWP configuration framework may allow the network entity 105 to switch configuration parameters relatively easily. For example, the network entity 105 may switch between BWP configurations or parameters without RRC reconfiguration or other configurations.

For example, by indicating multiple candidate sets of communication parameters to the UE 115 via some initial configuration message, the network entity 105 may dynamically activate and deactivate various sets of communication parameters during communication with the UE 115. The network entity 105 may switch communication parameters during communications, and may indicate the switch to the UE 115 via a control signal, such as a dynamic control signal (e.g., a DCI message, a MAC-control element (MAC-CE) or some other type of signaling). The network entity 105 may switch the set of communication parameters based on downlink traffic conditions. For example, the network entity 105 may switch from a set of communication parameters associated with a narrowband to a set of communication parameters associated with a wideband based on downlink traffic to the UE 115 (e.g., if the downlink traffic may be improved by increasing a bandwidth). The network entity 105 may transmit the control signal and indicate for the UE 115 to switch from a first set of communication parameters associated with a narrow bandwidth, a low rank, or a low modulation order to a second set of communication parameters associated with a wide bandwidth, a high rank, or a high modulation order. In some cases, the network entity 105 may switch to the second set of communication parameters in order to increase throughput to the UE 115, among other examples.

In some cases, the network entity 105 may benefit from communications in a relatively wide bandwidth, associated with a relatively high rank, or using a relatively high MCS. Such communication parameters may represent examples of relatively high throughput sets of communication parameters associated with a threshold (e.g., maximum) throughput, a threshold (e.g., minimum) processing timeline, or both. The threshold processing timeline may correspond to a minimum amount of time for the UE 115 to process and respond to communications. The higher throughput and reduced processing timeline may reduce transmission time, reduce network energy consumption, provide for the network entity 105 to serve more UEs, or any combination thereof as compared with a lower throughput and higher processing timeline. For example, by switching to the set of communication parameters associated with relatively high throughput (e.g., higher throughput than a previously used set of communication parameters), the network entity 105 may complete a transmission to the UE 115 in a shorter time period than if the network entity 105 uses the previously used set of communication parameters for the transmission. Other sets of communication parameters may be associated with a relatively narrow bandwidth, a relatively low rank, a relatively low MCS, or any combination thereof, and may be associated with lower throughput, greater processing timelines, or both. The network entity 105 may thereby dynamically signal for the UE 115 to switch sets of communication parameters to adjust a throughput, processing timeline, or both based on conditions associated with the communications.

The UE 115 may receive the control signal and may operate according to a greatest throughput, a smallest scheduling offset, or a shortest feedback timeline that are permitted by the set of communication parameters indicated via the control signal. That is, the UE 115 may assume and conform to the thresholds for communications using the indicated communication parameters. The UE 115 may thereby operate in a mode that supports up to the maximum throughput and supports processing within the minimum processing timeline. The UE 115 may enter a higher power mode to be ready to receive or transmit at the peak rate (e.g., according to the maximum throughput or minimum processing timeline). For example, if the UE 115 is scheduled for transmission or reception of one bit of data per second, but the set of configuration parameters associated with a maximum throughput of one gigabit per second, the UE 115 may enter a higher power mode in order to receive at the peak data rate (e.g., one gigabit per second, or some other peak data rate). The higher power mode at the UE 115 may involve higher clock frequency and a higher supply voltage to support the higher clock frequency and faster processing operations. The higher power mode may lead to a super-linear increase in power consumption. If the network entity 105 does not transmit to the UE 115 at the maximum throughput or schedule feedback from the UE 115 according to the minimum processing timeline, the UE 115 may unnecessarily enter the higher power mode, which may increase power consumption and processing. It may be beneficial for the network entity 105 to switch the set of communication parameters to a set of communication parameters that is associated with a wider bandwidth, higher rank, multiple activated cells, or higher MCS operation to improve or otherwise support reliable communications with one or more UEs while still communicating according to a reduced throughput, a higher processing timeline, or both.

In some cases, the UE 115 may communicate in accordance with a first communication profile (e.g., a first set of communication parameters, which also may be referred to as a first BWP configuration) associated with a narrow bandwidth (e.g., a narrowband operation mode). The maximum throughput may be limited by the maximum available bandwidth in the first communication profile. In other words, a sustained throughput may be limited. The first communication profile may additionally be associated with a first minimum processing timeline, which may correspond to a shortest time period between an end of a message received at the UE 115 and a beginning of a scheduled feedback opportunity. The UE 115 may process the received message and generate feedback within the first minimum processing timeline. Accordingly, the amount of data to decode within the first minimum processing timeline (e.g., feedback timeline) may be relatively low as compared with longer processing timelines, which may be supported by the relatively limited bandwidth available for scheduling in a slot prior to the scheduled feedback opportunity within the first communication profile. In other words, instantaneous throughput may be limited.

In some cases, the UE 115 may communicate in accordance with a second communication profile (e.g., a second set of communication parameters, which also may be referred to as a second BWP configuration) associated with a relatively wide bandwidth (e.g., wideband operation mode). The maximum throughput supported by the second communication profile may be higher than the maximum throughput associated with the first communication profile because the second communication profile may include a wider bandwidth. The network entity 105 may transmit more data within a given time period using the second communication profile than the first communication profile based on the wider bandwidth. For example, the scheduled resources may span across each of a first slot, a second slot, and a third slot using the first communication profile. That is, the network entity 105 may transmit data via the maximum bandwidth of the first communication profile in each slot. The scheduled resources may span the first slot using the second communication profile, and the second slot and the third slot may include unscheduled resources. That is, the network entity 105 may transmit the same amount of data via the maximum bandwidth of the first communication profile in a single slot, which illustrates the increased data rate and data throughput supported by the second communication profile.

While communicating according to the second communication profile, the network entity 105 may schedule communications in any of the first slot, the second slot, and the third slot. In examples in which the UE 115 receives data in the third slot, the UE 115 may have a same processing timeline as described with reference to the first communication profile. That is, if the UE 115 receives data in the third slot, the UE 115 may be scheduled to transmit feedback for the data by the same feedback deadline as in the first communication profile. Alternatively, the UE 115 may receive data in the first slot but not in the second slot or the third slot. In some examples, without receiving an indication that the UE 115 is to operate according to a reduced throughput, a higher processing timeline, or both, the UE 115 may enter a higher power mode unnecessarily. That is, the UE 115 may assume scheduling at a higher throughput, lower processing timeline, or both in each of the first slot, the second slot, and the third slot (e.g., despite only receiving data in the first slot). However, when the UE 115 receives an indication of the reduced throughput and higher processing timeline, the UE 115 may refrain from entering the higher power mode. For example, the network entity 105 may indicate at least one of a threshold throughput (e.g., a maximum schedulable sustained throughput) lower than the maximum throughput (e.g., peak throughput possible given the current configuration) or a threshold processing timeline (e.g., minimum data processing (or feedback) timeline) larger than the minimum processing timeline (e.g., minimum possible value reported by the UE 115).

By using the second communication profile associated with the relatively wide bandwidth and applying the threshold throughput lower than the maximum throughput or the threshold processing timeline larger than the minimum processing timeline, the UE 115 may relax one or more parameters related to processing (e.g., relax a baseband) while maintaining a relatively high power state. For example, the UE 115 may be scheduled with a bandwidth of 400 MHz and operate a baseband clock with a clock frequency of 100 MHz. In such examples, the UE 115 may perform baseband operations (e.g., processing) over one or more subsequent slots from the slot scheduled with the bandwidth of 400 MHZ (e.g., due to the reduced clock frequency). In other words, the processing may spill into subsequent slots. That is, the UE 115 may process a downlink message with the relatively wide bandwidth (e.g., in wideband) according to the threshold throughput or the threshold processing timeline over a quantity of slots after the slot in which the downlink message is received. Operating the baseband clock with the relatively lower clock frequency may support improved power saving compared to operating the baseband clock at a same frequency as the scheduled bandwidth of 400 MHZ.

Additionally, in some wireless communication systems, the network entity 105 and the UE 115 may support a single DCI scheduling multiple transmissions (e.g., multiple PDSCHs or PUSCHs). In some cases, scheduling the multiple transmissions via the single DCI may support reduced overhead. That is, rather than transmitting a DCI to schedule each transmission of the multiple transmissions, the network entity 105 may transmit the single DCI. Additionally, the network entity 105 may use the single DCI to schedule the multiple transmissions in the context of an extended reality (XR) application, such as for XR transmission of a burst. The DCI may schedule multiple transmissions in respective slots, where each transmission may correspond to (e.g., and not exceed) a respective slot. In some cases, the multiple transmissions may be distinct transmissions. That is, the multiple transmissions may not include repetitions or retransmissions of a transmission. Additionally, the DCI may schedule the multiple transmissions in respective slots, where the slots may be contiguous or non-c ontiguous. In other words, there may be gaps between adjacent transmissions scheduled by the DCI. A quantity of slots separating adjacent transmissions may, in some aspects, satisfy a threshold gap (e.g., a maximum gap limitation). For example, the threshold gap may be one of multiple RRC parameters. In some cases, a row of a TDRA table may indicate transmissions that are in consecutive or non-c onsecutive slots by configuring one or more parameters for each transmission in the row of the TDRA table. For example, each row of the TDRA table may correspond to a respective transmission and may indicate parameters including a start and length indicator value (SLIV), mapping type, slot offset (e.g., K₀, K₂, etc.), or any combination thereof.

The network entity 105 and the UE 115 may support the single DCI scheduling the multiple transmissions based on whether the network entity 105 and the UE 115 are connected via a single TRP or multiple TRPs. In the example of a single TRP or multiple TRPs and a first bandwidth (e.g., 120 kHz), the network entity 105 may transmit the single DCI based on a capability of the UE 115. In the example of the single TRP in a second bandwidth (e.g., 480 kHz or 960 kHz), the network entity 105 may schedule transport blocks on a per-slot basis (e.g., one transport block per slot). In the example of the multiple TRPs in the second bandwidth, the network entity 105 may schedule the transport blocks on a per-TRP basis (e.g., one transport block per TRP).

Techniques described herein may support indication, in the single DCI scheduling multiple transmissions, of how each of the multiple transmissions are to be processed. For example, in examples in which the UE 115 has the capability to process transmissions with the relatively wide frequency range according to the threshold throughput, the threshold processing time, or both (e.g., typically associated with a relatively narrow frequency range), the network entity 105 may indicate how multiple transmissions scheduled by the single DCI are to be processed.

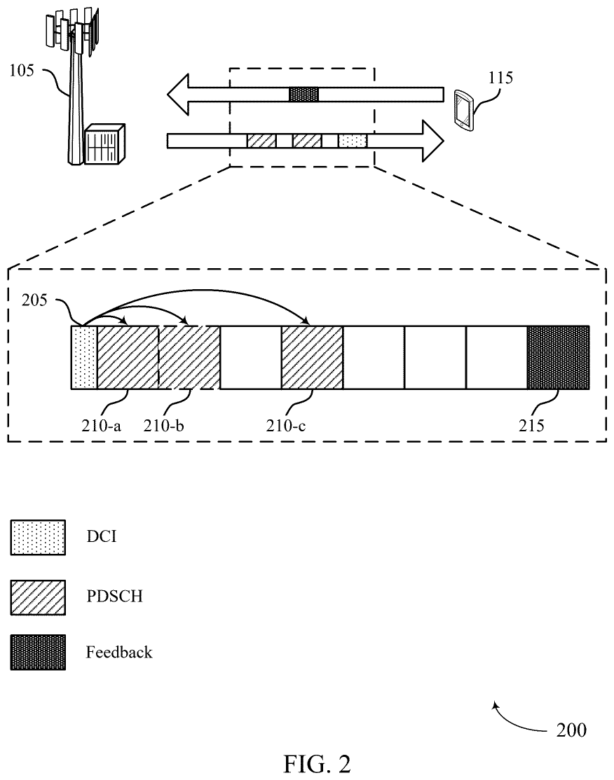

FIG. 2 shows an example of a wireless communications system 200 that supports communication scheduling for reduced throughput in wideband in accordance with one or more aspects of the present disclosure. The wireless communications system 200 may implement or be implemented by various aspects of the wireless communications system 100. For example, the wireless communications system 200 may include a network entity 105 and a UE 115, which may represent examples of corresponding devices as described with reference to FIG. 1.

The network entity 105 may schedule two or more transmissions via a DCI 205 (e.g., a single DCI). For example, the network entity 105 may output the DCI 205 scheduling a PDSCH 210-a, a PDSCH 210-b, and a PDSCH 210-c. While the example of FIG. 2 illustrates and describes the DCI 205 as scheduling two or more PDSCHs, it may be understood that the DCI 205 may schedule two or more PUSCHs. The DCI 205 may be indicative that at least one of the PDSCH 210-a, the PDSCH 210-b, and the PDSCH 210-c is to be processed in accordance with a first threshold throughput. For example, the first threshold throughput may be associated with or referred to as a low throughput mode, relaxed baseband processing, reduced peak throughput, or the like. The first threshold throughput may be less than a second threshold throughput configured at the UE 115. The second threshold throughput may be associated with a set of parameters of a configuration of the UE 115, such as a BWP configuration.

For example, the UE 115 may be configured with at least two sets of configuration parameters, such as BWP configurations or configuration profiles. Different sets of configuration parameters may be associated with different bandwidths, including a narrow bandwidth (e.g., narrowband) or a wide bandwidth (e.g., wideband). While operating in wideband, the UE 115 may apply the second threshold throughput associated with unless indicated otherwise. That is, the UE 115 may apply the second threshold throughput as part of the BWP configuration for wideband operations. However, to reduce power consumption at the UE 115, the network entity 105 may indicate that the UE 115 is to apply the first threshold throughput, which may be less than the second threshold throughput. As an example, the first threshold throughput may be similar to a threshold throughput applied when operating according to the first set of configuration parameters (e.g., in narrowband).

In some examples, the DCI 205 may be indicative that one of the PDSCH 210-a, the PDSCH 210-b, or the PDSCH 210-c are to be processed in accordance with the first threshold throughput. As an example, the DCI 205 may be indicative that a last transmission scheduled by the DCI 205, in time, is to be processed in accordance with the first threshold throughput. That is, in the example of FIG. 2, the DCI 205 may be indicative that the PDSCH 210-c is to be processed in accordance with the first threshold throughput. In some other examples, the DCI 205 may be indicative that the PDSCH 210-a, the PDSCH 210-b, and the PDSCH 210-c are to be processed in accordance with the first threshold throughput. In other words, the DCI 205 may be indicative that all of the transmission scheduled by the DCI 205 are to be scheduled in accordance with the first threshold throughput. In another example, the DCI 205 may be indicative that a subset of the PDSCH 210-a, the PDSCH 210-b, and the PDSCH 210-c are to be processed in accordance with the first threshold throughput. That is, the DCI 205 may indicate that one, a subset, or all of the transmissions scheduled by the DCI 205 are to be processed in accordance with the first threshold throughput. Alternatively, the DCI 205 may not include the indication that any of the PDSCH 210-a, the PDSCH 210-b, or the PDSCH 210-c are to be processed in accordance with the first threshold throughput.

The DCI 205 may indicate that the at least one PDSCH of the PDSCH 210-a, the PDSCH 210-b, and the PDSCH 210-b is to be processed in accordance with the first threshold throughput via one or more fields. In other words, the DCI 205 may explicitly, through the one or more fields, indicate whether the first threshold throughput is to be applied at the UE 115. For example, the DCI 205 may include a field (e.g., “power state”) with a bitmap indicating whether the PDSCHs are to be processed in accordance with the first threshold throughput or the second threshold throughput. As an example, a first value in the field may be indicative of a corresponding PDSCH being processed in accordance with the first threshold throughput, while a second value in the field may be indicative of a corresponding PDSCH being processed in accordance with the second threshold throughput.

The DCI 205 may indicate threshold throughputs for PDSCH processing on a per-transport block basis. For example, the DCI 205 may include multiple fields corresponding to multiple transport blocks of the PDSCHs scheduled by the DCI 205. That is, the DCI 205 may include a first field corresponding to a first transport block, a second field corresponding to a second transport block, and so on. Alternatively, the DCI 205 may indicate threshold throughputs for PDSCH processing on a PDSCH basis. For example, the DCI 205 may include a first field corresponding to the PDSCH 210-a, a second field corresponding to the PDSCH 210-b, and so on.

In some examples, the network entity 105 may indicate the first threshold throughput (e.g., the value of the first threshold throughput) via a scaling factor. For example, as a part of capability negotiations between the network entity 105 and the UE 115, the network entity 105 may indicate a scaling factor associated with the first threshold throughput. The network entity 105, as an example, may indicate the scaling factor via an RRC message. The UE 115 may determine the first threshold throughput in accordance with the scaling factor. That is, the UE 115 may determine the first threshold throughput based on dividing the second threshold throughput by the scaling factor. The capability negotiations, and the indication of the scaling factor, may occur prior to transmission of the DCI 205. For example, the DCI 205 may be indicative that the previously configured scaling factor is to be applied for the at least one PDSCH. In other words, the DCI 205 may activate the first threshold throughput, where the first threshold throughput is determined at the UE 115 in accordance with the RRC configured scaling factor.

The UE 115 may determine (e.g., implicitly) whether the at least one PDSCH is to be processed in accordance with the first threshold throughput based on gaps between resource allocations of the PDSCH 205-a, the PDSCH 205-b, and the PDSCH 205-c. For example, the UE 115 may determine that the PDSCH 205-a is to be processed in accordance with the second threshold throughput based on the PDSCH 205-b being scheduled in a slot immediately following the PDSCH 205-a. In other words, the UE 115 may determine to process the PDSCH 205-a in accordance with the second threshold throughput based on an absence of a gap between the PDSCH 205-a and a next (e.g., in time) scheduled PDSCH (e.g., the PDSCH 205-b). Alternatively, the UE 115 may determine that the PDSCH 205-c is to be processed in accordance with the first threshold throughput based on an absence of a transmission scheduled in a quantity of slots after the PDSCH 205-c. In other words, the first threshold throughput may be associated with a first processing timeline, where the first processing timeline includes a quantity of slots exceeding a quantity of slots allocated for a scheduled PDSCH processed according to the first threshold throughput. If the UE 115 is not scheduled with a transmission for a duration of time after a scheduled PDSCH equal or greater to the first processing timeline, the UE 115 may determine to process the scheduled PDSCH in accordance with the first threshold throughput.

The DCI 205 may include an indication of a row of a TDRA table. For example, the UE 115 may include at least two TDRA tables corresponding to the first threshold throughput and the second threshold throughput. Each TDRA table may include one or more parameters corresponding to processing in accordance with the first threshold throughput and the second threshold throughput. For example, the TDRA tables may include Ko offsets, mapping offsets, or both. In other words, a first row of the TDRA table may correspond to processing PDSCH in accordance with the first threshold throughput and may include an indication of one or more first parameters (e.g., slot offsets, mapping offsets, etc.), while a second row of the TDRA table may correspond to processing PDSCH in accordance with the second threshold throughput and may include an indication of one or more second parameters (e.g., slot offsets, mapping offsets, etc.). The UE 115 may determine a time domain allocation associated with the PDSCH 210-a, the PDSCH 210-b, and the PDSCH 210-c based on or according to information in the indicated row of the TDRA table. As an example, the UE 115 may determine a starting symbol, a length, or both allocated for each of the PDSCH 210-a, the PDSCH 210-b, and the PDSCH 210-c.

The network entity 105 may output the PDSCHs scheduled by the DCI 205 in accordance with a beam mapping pattern. For example, the network entity 105 may output, the UE 115 may receive, or both the PDSCHs scheduled by the DCI 205 in accordance with a cyclical beam mapping pattern or a sequential beam mapping pattern. The beam mapping patterns may support repetitions of the PDSCHs scheduled by the DCI 205. For example, the network entity 105 may output the PDSCHs in accordance with the cyclical beam mapping pattern in which the network entity 105 may output the PDSCH 210-a, the PDSCH 210-b, then the PDSCH 210-c followed by a repetition of the PDSCH 210-a, the PDSCH 210-b, then the PDSCH 210-c (e.g., 123123 . . . ). In another example, the network entity 105 may output the PDSCHs in accordance with the sequential mapping pattern in which the network entity 105 may output the PDSCH 210-a, one or more repetitions of the PDSCH 210-a, the PDSCH 210-b, one or more repetitions of the PDSCH 210-b, the PDSCH 210-c, and one or more repetitions of the PDSCH 210-c (e.g., 112233 . . . ).

In examples in which the at least one PDSCH is to be processed in accordance with the first threshold throughput, the network entity 105 may include additional processing time per beam. For example, the DCI 205 may schedule the PDSCH 210-a and the PDSCH 210-c. In examples in which both the PDSCH 210-a and the PDSCH 210-c are to be processed in accordance with the first threshold throughput, the network entity 105 may transmit the PDSCH 210-a and the PDSCH 210-c in accordance with a cyclic mapping pattern in which, after each transmission of a PDSCH, the network entity 105 may include a processing duration (e.g., 1xx2xx1xx2xx . . . ). Or, if the network entity 105 outputs the PDSCHs according to a sequential mapping pattern, the network entity 105 may include the processing duration after a last repetition of the PDSCHs (e.g., 11xx22xx . . . ). Alternatively, in examples in which the PDSCH 210-c is to be processed in accordance with the first threshold throughput, the network entity 105 may transmit the PDSCH 210-a and the PDSCH 210-c in accordance with the cyclic mapping pattern in which, after transmission of the PDSCH 210-c, the network entity may include the processing duration (e.g., 12xx12xx . . . ). Or, if the network entity 105 outputs the PDSCHs according to the sequential mapping, the network entity 105 may include the processing duration after a last repetition of the PDSCH 210-c (e.g., 1122xx . . . ).

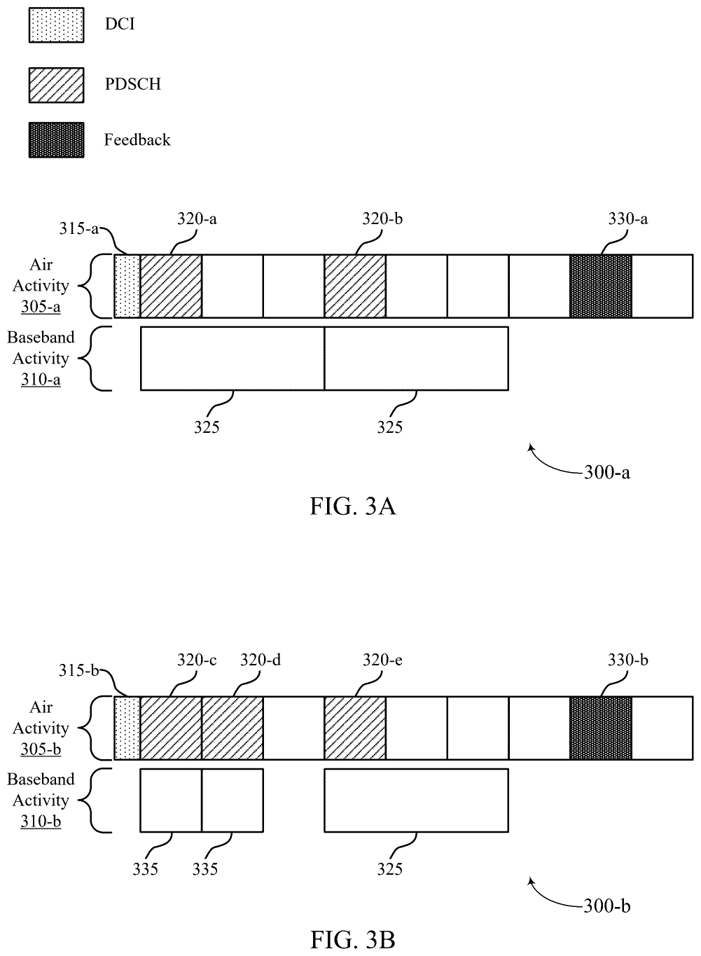

The UE 115 may process the PDSCH 210-a, the PDSCH 210-b, and the PDSCH 210-c in accordance with the DCI 205. For example, the UE 115 may process each of the PDSCH 210-a, the PDSCH 210-b, and the PDSCH 210-c in accordance with an indication (e.g., explicit or implicit) in the DCI 205 of whether each respective PDSCH is to be processed in accordance with the first threshold throughput or the second threshold throughput. Processing the PDSCHs in accordance with the first threshold throughput and the second threshold throughput may be described in greater detail elsewhere herein, including with reference to FIGS. 3A and 3B.

The UE 115, after processing the PDSCH 210-a, the PDSCH 210-b, or the PDSCH 210-c, may transmit feedback 215. The UE 115 may transmit the feedback 215 based on whether each of the PDSCH 210-a, the PDSCH 210-b, or the PDSCH 210-c were successfully decoded by the UE 115. For example, the UE 115 may transmit an acknowledgement (ACK) or a negative ACK (NACK) message based on successfully decoding a PDSCH or unsuccessfully decoding a PDSCH, respectively. The UE 115 may transmit feedback for multiple PDSCHs of the PDSCH 210-a, the PDSCH 210-b, and the PDSCH 210-c simultaneously. For example, the UE 115 may transmit feedback for two or more of the PDSCH 210-a, the PDSCH 210-b, and the PDSCH 210-c in a same uplink resource (e.g., PUCCH). In some aspects, the UE 115 may transmit different feedback messages for PDSCHs processed according to different throughput thresholds. For example, the UE 115 may transmit a first feedback message in a first uplink resource indicative of feedback for one or more first PDSCHs scheduled by the DCI 205 which were processed in accordance with the first throughput threshold. The UE 115 may (e.g., separately) transmit a second feedback message in a second uplink resource indicative of feedback for one or more second PDSCHs scheduled by the DCI 205 which were processed in accordance with the second throughput threshold. Transmitting feedback for multiple PDSCHs (e.g., processed in accordance with a same threshold throughput or different threshold throughputs) may reduce overhead and latency at the UE 115, the network entity 105, or both.

In some other examples, the UE 115 may transmit the feedback 215 in accordance with different codebooks associated with the first threshold throughput and the second threshold throughput. For example, the network entity 105 may transmit control signaling indicative of a first slot offset (e.g., K₁) associated with processing in accordance with the first threshold throughput and a second slot offset (e.g., K₁′) associated with processing in accordance with the second threshold throughput. The first slot offset and the second slot offset may be representative of an offset from the DCI 205 to an uplink resource (e.g., a PUCCH). The UE 115 may generate, based on the first slot offset and the second slot offset, a first sub-c odebook (e.g., a first codebook) and a second sub-codebook (e.g., a second codebook) for a PUCCH cell group. For example, the UE 115 may generate a first codebook for the first threshold throughput and the second codebook for the second threshold throughput. The UE 115 may bundle feedback of PDSCHs processed in accordance with the first threshold throughput. For example, the UE 115 may bundle the feedback (e.g., ACK/NACK) to reduce a codebook size for applying a logical AND. Additionally, the UE 115 may bundle feedback of PDSCHs processed in accordance with the second threshold throughput. In other words, the UE 115 may transmit a first feedback message indicative of whether one or more PDSCHs processed in accordance with the first threshold throughput are successfully decoded by the UE 115 and (e.g., separately, via different resources, etc.) a second feedback message indicative of whether one or more PDSCHs processed in accordance with the second threshold throughput are separately decoded by the UE 115. The UE 115 may transmit the first feedback message in accordance with the first slot offset and the second feedback message in accordance with the second slot offset.

FIG. 3A shows an example of an air and baseband activity diagram 300-a that supports communication scheduling for reduced throughput in wideband in accordance with one or more aspects of the present disclosure. The air and baseband activity diagram 300-a may implement or be implemented by various aspects of the wireless communications system 100, the wireless communications system 200, or both. For example, the air and baseband activity diagram 300-a may include DCI, PDSCH, and feedback messages, which may be examples of the DCI 205, PDSCHs 210, and feedback 215 as described with reference to FIG. 2.

In the example of FIG. 3A, wireless communication devices, such as a network entity and a UE, may output transmissions, process transmissions, or both. Air activity 305-a may illustrate one or more transmissions exchanged between the wireless communication devices during different slots, while baseband activity 310-a may illustrate processing activity at a receiving device. The DCI 315-a may schedule a PDSCH 320-a and a PDSCH 320-b in a first slot and in a fourth slot, respectively. The DCI 315-a may indicate (e.g., implicitly or explicitly) whether either of the PDSCH 320-a or the PDSCH 320-b are to be processed in accordance with a first (e.g., reduced) threshold throughput. For example, the first threshold throughput may be referred to herein as a reduced peak threshold throughput and may be reduced relative to a second throughput configured at a wireless communication device when operating in a relatively wide frequency range (e.g., in wideband). In other words, when operating in wideband, the wireless communication device may (e.g., by default) apply the second threshold throughput, which may be a relatively high threshold (e.g., maximum) throughput. For example, the wireless communication device may operate according to a BWP configuration associated with wideband operations, where the BWP configuration includes or is associated with the second threshold throughput.

The PDSCH 320-a and the PDSCH 320-b may both be processed in accordance with the first threshold throughput. For example, because the first threshold throughput is reduced relative to the second threshold throughput configured at the wireless communication device for wideband communications, the wireless communication device may process the PDSCH 320-a and the PDSCH 320-b over an increased processing timeline 325. That is, to accommodate for the first threshold throughput, the wireless communication device may process the PDSCH 320-a and the PDSCH 320-b over a longer duration relative to the second threshold throughput (e.g., associated with the BWP configuration for wideband). Based on the PDSCH 320-a and the PDSCH 320-b both being processed in accordance with the first threshold throughput, the wireless communication device may not be scheduled for communication in one or more slots following the PDSCH 320-a and the PDSCH 320-b. For example, the wireless communication device may not be scheduled in a second slot or a third slot after the PDSCH 320-a, as the wireless communication device processes the PDSCH 320-a in the second slot and the third slot in accordance with the reduced threshold throughput. The PDSCH 320-b following the PDSCH 320-a may be scheduled in accordance with the increased processing timeline 325 associated with the first threshold throughput (e.g., if a buffer size is to not increase). That is, the PDSCH 320-b may be scheduled to be received at the wireless communication device after processing of the PDSCH 320-a over the increased processing timeline 325. For example, the air activity 305-a may include gaps in scheduling between PDSCHs.

By processing the PDSCH 320-a and the PDSCH 320-b according to the first threshold throughput and the increased processing timeline 325, the wireless communication device may reduce a power consumption. For example, the wireless communication device may process the PDSCH 320-a and the PDSCH 320-b at a relatively low power compared to a power associated with wideband operations performed according to the second threshold throughput configured at the wireless communication device. In other words, processing the PDSCH 320-a and the PDSCH 320-b supports power savings at the wireless communication device.

The wireless communication device may transmit feedback 330-a after processing the PDSCH 320-a and the PDSCH 320-b. In some aspects, based on the PDSCH 320-a and the PDSCH 320-b both being processed in accordance with the first threshold throughput, the wireless communication device may transmit feedback for both the PDSCH 320-a and the PDSCH 320-b in a same uplink resource. In other words, the feedback 330-a may include first feedback for the PDSCH 320-a and second feedback for the PDSCH 320-b.

FIG. 3B shows an example of an air and baseband activity diagram 300-b that supports communication scheduling for reduced throughput in wideband in accordance with one or more aspects of the present disclosure. The air and baseband activity diagram 300-b may implement or be implemented by various aspects of the wireless communications system 100, the wireless communications system 200, or both. For example, the air and baseband activity diagram 300-b may include DCI, PDSCH, and feedback messages, which may be examples of the DCI 205, PDSCHs 210, and feedback 215 as described with reference to FIG. 2.

In the example of FIG. 3B, wireless communication devices, such as a network entity and a UE, may output transmissions, process transmissions, or both. Air activity 305-b may illustrate one or more transmissions exchanged between the wireless communication devices during different slots, while baseband activity 310-b may illustrate processing activity at a receiving device. The DCI 315-b may schedule a PDSCH 320-c, a PDSCH 320-d, and a PDSCH 320-c in a first slot, in a second slot, and in a fourth slot, respectively. The DCI 315-b may indicate (e.g., implicitly or explicitly) whether each of the PDSCH 320-c, a PDSCH 320-d, and a PDSCH 320-e are to be processed in accordance with a first threshold throughput.

The PDSCH 320-c and the PDSCH 320-d may both be processed in accordance with a second (e.g., default) threshold throughput. The second threshold throughput may be referred to herein as a configured threshold throughput or a maximum threshold throughput. A wireless communication device may process the PDSCH 320-c and the PDSCH 320-d over a configured (e.g., default) processing timeline 335. The configured processing timeline 335 may correspond to a duration of a slot in which the PDSCH 320-c and the PDSCH 320-d are received. That is, according to the configured processing timeline 335 and a second threshold throughput, the wireless communication device may complete processing of a PDSCH in the slot the PDSCH was received. In such examples, the wireless communication device may be scheduled in one or more slots after the slots in which the PDSCH 320-c and the PDSCH 320-d are received.

The PDSCH 320-e may be processed in accordance with the first threshold throughput. For example, because the first threshold throughput is reduced relative to the second threshold throughput at the wireless communication device for wideband communications, the wireless communication device may process the PDSCH 320-c over the increased processing timeline 325. That is, to accommodate for the first threshold throughput, the wireless communication device may process the PDSCH 320-e over a longer duration relative to the second threshold throughput (e.g., the default, the threshold configured at the device, etc.).

By processing the PDSCH 320-e according to the first threshold throughput and the increased processing timeline 325, the wireless communication device may reduce a power consumption. For example, the wireless communication device may process the PDSCH 320-e at a relatively low power compared to a power associated with wideband operations performed according to the second threshold throughput (e.g., the default) configured at the wireless communication device. In other words, processing the PDSCH 320-e may support power savings at the wireless communication device. Additionally, by processing the PDSCH 320-c and the PDSCH 320-d according to the second threshold throughput and over the configured processing timeline 330, the wireless communication device may reduce a latency. That is, the wireless communication device may process the PDSCH 320-c and the PDSCH 320-d more quickly relative to the PDSCH 320-e processed over the increased processing timeline 225.

The wireless communication device may transmit feedback 330-b after processing the PDSCH 320-c, the PDSCH 320-d, and the PDSCH 320-c. In some aspects, based on the PDSCH 320-c and the PDSCH 320-d both being processed in accordance with the second threshold throughput, the wireless communication device may transmit feedback for both the PDSCH 320-c and the PDSCH 320-d in a same uplink resource. For example, the wireless communication device may transmit a first feedback message in a first uplink resource corresponding to the PDSCH 320-c and the PDSCH 320-d, which were processed in accordance with the second threshold throughput. The wireless communication device may transmit a second feedback message in a second uplink resource (e.g., different than the first uplink resource) corresponding to the PDSCH 320-e, which was processed in accordance with the first threshold throughput.

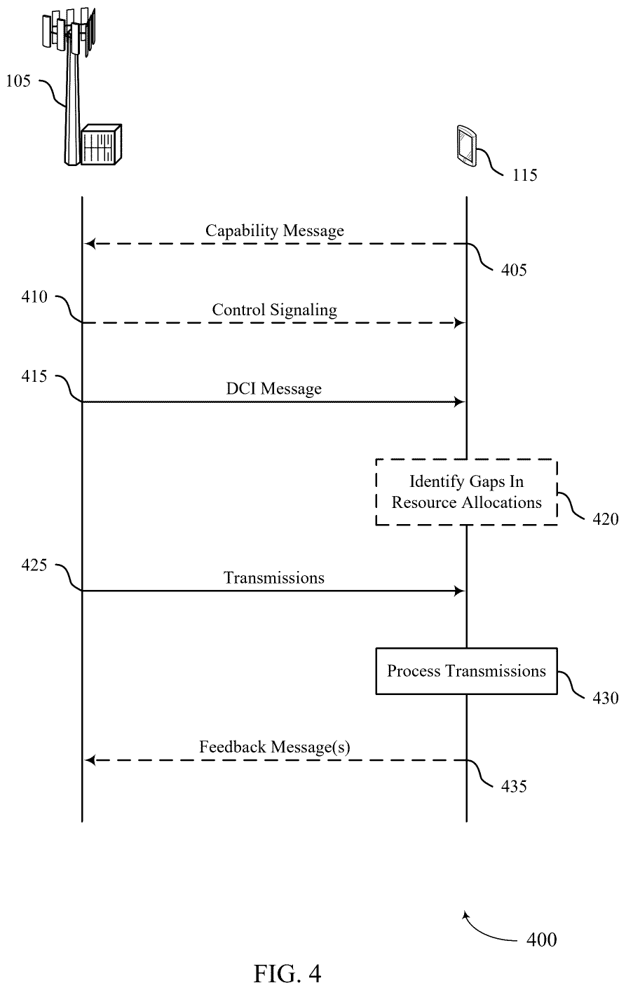

FIG. 4 shows an example of a process flow 400 that supports communication scheduling for reduced throughput in wideband in accordance with one or more aspects of the present disclosure. The process flow 400 may implement or be implemented by aspects of the wireless communications system 100, the wireless communications system 200, the air and baseband activity diagram 300-a, and the air and baseband activity diagram 300-b as described with reference to FIGS. 1-3. For example, the process flow 400 may include a network entity 105 and a UE 115, which may be examples of corresponding devices as described with reference to FIGS. 1 and 2.

Alternative examples of the following may be implemented, where some operations are performed in a different order than described or are not performed at all. In some cases, operations may include additional features not mentioned below, or further operations may be added. Although the network entity 105 and the UE 115 are shown performing the operations of the process flow 400, some aspects of some operations may also be performed by one or more other wireless devices.

At 405, the UE 115 may transmit a capability message. For example, the UE 115 may transmit the capability message indicative of a capability of the UE 115 associated with processing. In some examples, the UE 115 may transmit the capability message as part of a capability negotiation with the network entity 105. In response to the capability message, at 410, the network entity 105 may output control signaling. For example, the UE 115 may receive control signaling, responsive to the capability message, that is indicative of a scaling factor. A first threshold throughput may be based on the scaling factor. The first threshold throughput may be associated with an operating mode at the UE 115, such as a wideband mode, a reduced throughput mode, or both.

Additionally, or alternatively, at 410, the UE 115 may receive control signaling indicative of a first slot offset and a second slot offset. The first slot offset and the second slot offset, which may be examples of K1 values, may relate to respective durations of time between a DCI message and feedback messages associated with transmissions scheduled by the DCI message. The first slot offset may be associated with the first threshold throughput (e.g., wideband processing), and the second slot offset may be associated with a second threshold throughput (e.g., narrowband processing).

At 415, the network entity 105 may output a DCI message. For example, the UE 115 may receive a DCI message scheduling two or more transmissions. The DCI message may be indicative that at least one transmission of the two or more transmissions is to be processed in accordance with a first threshold throughput, where the first threshold throughput is less than a second threshold throughput configured at the UE 115.

In some examples, the DCI message may be indicative that the two or more transmissions are to be processed in accordance with the first threshold throughput. In other words, the DCI message may indicate that a single transmission is to be processed in accordance with the first threshold throughput, a subset of the two or more transmissions are to be processed in accordance with the threshold throughput, or that all of the transmissions are to be processed in accordance with the threshold throughput.

The UE 115 may receive, in the DCI message, one or more DCI fields indicative that the at least one transmission is to be processed in accordance with the first threshold throughput. For example, the DCI message may include a field (e.g., power state) which indicates whether a transmission scheduled by the DCI is to be processed according to the first threshold throughput or the second threshold throughput. For example, a DCI field may include a first value indicative of the first threshold throughput or a second value indicative of the second threshold throughput.

The one or more DCI fields may correspond to respective transport blocks of the two or more transmissions scheduled by the DCI message. In other words, the two or more transmissions may include multiple transport blocks, and the DCI message may include respective fields corresponding to each transport block of the two or more transmissions scheduled by the DCI. In some other examples, the one or more downlink control information fields correspond to the two or more transmissions scheduled by the downlink control information message. That is, the DCI message may include a single field indicative a threshold throughput according to which the two or more transmissions are to be processed.

The UE 115 may receive, in the DCI message, an indication of a row of a TDRA table at the UE 115, where the row of the TDRA table is indicative of the first threshold throughput and a slot offset (e.g., K₀) between the DCI message and the at least one transmission of the two or more transmissions. For example, the TDRA table may be predefined or preconfigured at the UE 115. The UE 115 may receive the at least one transmission in accordance with the slot offset. In other words, the UE 115 may receive the at least one transmission after a quantity of slots from the DCI message, where the quantity of slots corresponds to the slot offset.

At 420, the UE 115 may identify gaps in resource allocations. For example, the UE 115 may receive a resource allocation and determine whether there are gaps between allocations for respective transmissions of the two or more transmissions scheduled by the DCI. The UE 115 may determine to process the at least one transmission of the two or more transmissions in accordance with the first threshold throughput based on one or more gaps between respective resource allocations associated with the two or more transmissions. For example, the UE 115 may determine to process the at least one transmission in accordance with the first threshold throughput based on a gap between a resource allocation of the at least one transmission and a resource allocation of subsequent transmission (e.g., subsequent in time) of the two or more transmissions. Alternatively, the UE 115 may determine to process the at least one transmission in accordance with the second threshold throughput based on an absence of a gap between the resource allocation of the at least one transmission and the resource allocation of the subsequent transmission. In other words, the UE 115 may determine whether to use the first threshold throughput or the second threshold throughput based on whether a transmission is to be followed immediately by another transmission.

At 425, the network entity 105 may output transmissions. For example, the network entity 105 may output, based on the DCI message, the two or more transmissions. At 430, the UE 115 may process the transmissions. For example, the UE 115 may receive the at least one transmission, where the at least one transmission is processed in accordance with the first threshold throughput. In examples in which the DCI indicates that the two or more transmissions are to be processed in accordance with the first threshold throughput, the UE 115 may receive the two or more transmissions, where the two or more transmissions are processed in accordance with the first threshold throughput. The UE 115 may process transmissions of the two or more transmissions which are not indicated to be processed in accordance with the first threshold throughput in accordance with the second threshold throughput (e.g., as a default).

In some examples, the UE 115 may receive the two or more transmissions scheduled by the DCI message in accordance with a beam mapping pattern, where the beam mapping pattern is one of a cyclic beam mapping pattern or a periodic beam mapping pattern. For example, for the two or more transmissions, the network entity 105 and the UE 115 may support more than two repetitions with different beam mapping patterns. In some aspects, the beam mapping pattern may be based on the at least one transmission of the two or more transmissions being processed in accordance with the first threshold throughput. That is, the beam mapping pattern may include additional processing time per beam to account for the first threshold throughput being applied by the UE 115 to the at least one transmission.

At 435, the UE 115 may transmit a feedback message. For example, the UE 115 may transmit one or more feedback messages indicative of whether the at least one transmission and one or more other transmissions of the two or more transmissions are successfully decoded by the UE 115. In such examples, the at least one transmission and the one or more other transmissions may be processed in accordance with the first threshold throughput. The UE 115 may transmit the one or more feedback messages via a same set of resources or respective sets of resources. In other words, the UE 115 may transmit the one or more feedback messages (e.g., in a PUCCH) for transmissions processed according to the first threshold throughput, such as processed in wideband.

In examples in which the control signaling at 410 indicates the first slot offset and the second slot offset, the UE 115 may transmit the feedback messages in accordance with the first slot offset and the second slot offset. For example, the UE 115 may transmit first feedback in accordance with the first slot offset for one or more first transmissions of the two or more transmissions scheduled by the DCI message, where the one or more first transmissions are processed in accordance with the first threshold throughput. Additionally, the UE 115 may transmit second feedback in accordance with the second slot offset for one or more second transmissions of the two or more transmissions scheduled by the downlink control information message, where the one or more second transmissions are processed in accordance with the second threshold throughput.

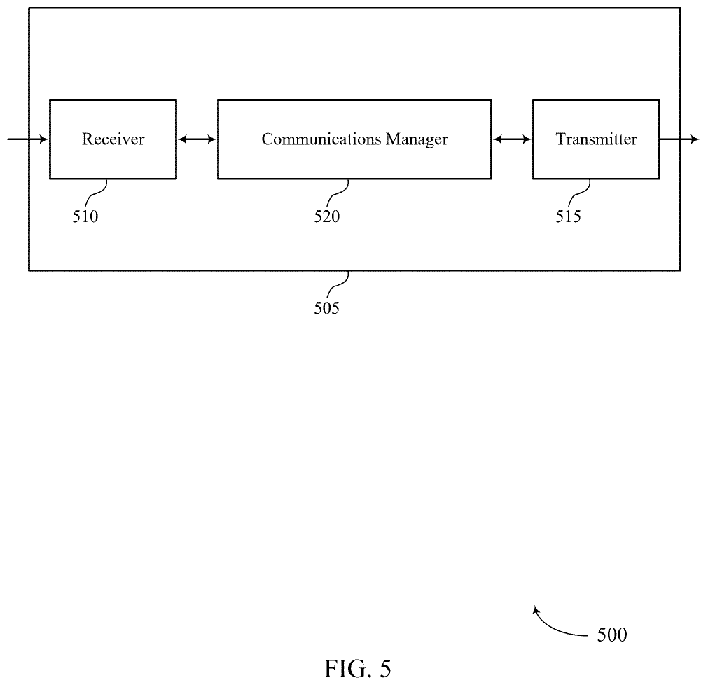

FIG. 5 shows a block diagram 500 of a device 505 that supports communication scheduling for reduced throughput in wideband in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to communication scheduling for reduced throughput in wideband). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to communication scheduling for reduced throughput in wideband). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of communication scheduling for reduced throughput in wideband as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE. The communications manager 520 is capable of, configured to, or operable to support a means for receiving, based on the DCI message, the at least one transmission, where the at least one transmission is processed in accordance with the first threshold throughput.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

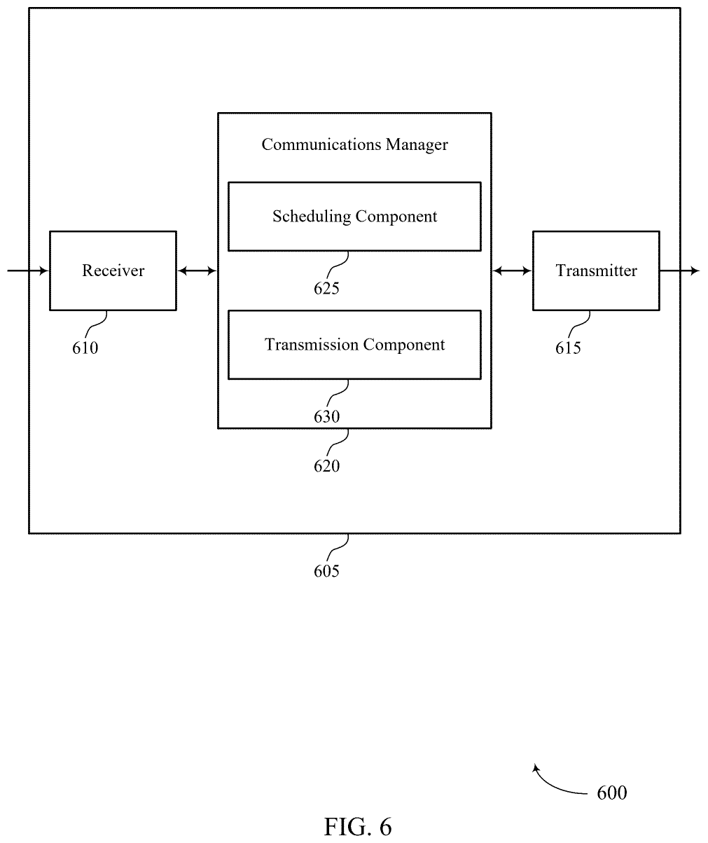

FIG. 6 shows a block diagram 600 of a device 605 that supports communication scheduling for reduced throughput in wideband in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to communication scheduling for reduced throughput in wideband). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to communication scheduling for reduced throughput in wideband). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of communication scheduling for reduced throughput in wideband as described herein. For example, the communications manager 620 may include a scheduling component 625 a transmission component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The scheduling component 625 is capable of, configured to, or operable to support a means for receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE. The transmission component 630 is capable of, configured to, or operable to support a means for receiving, based on the DCI message, the at least one transmission, where the at least one transmission is processed in accordance with the first threshold throughput.

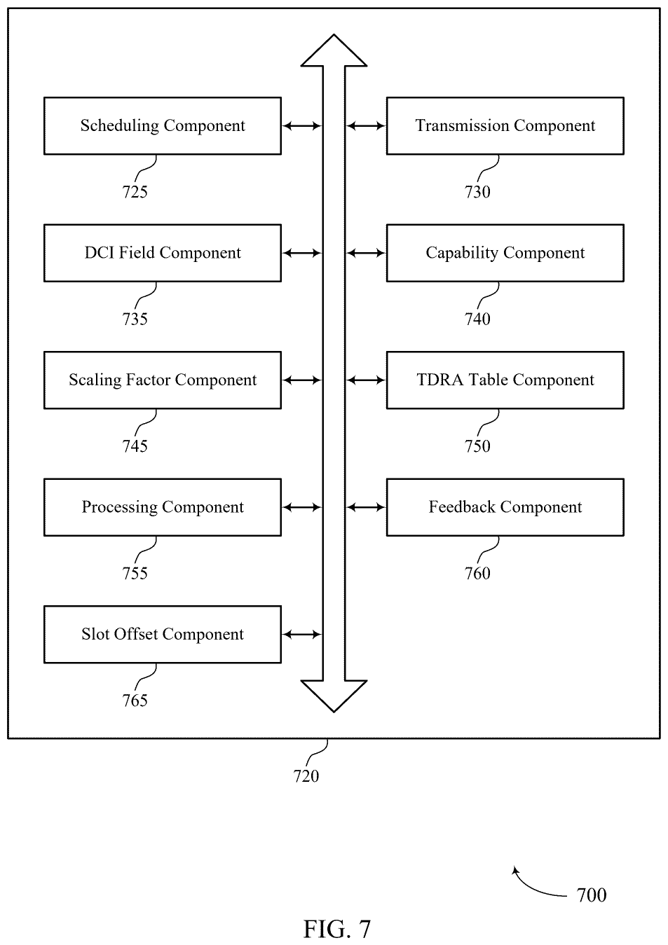

FIG. 7 shows a block diagram 700 of a communications manager 720 that supports communication scheduling for reduced throughput in wideband in accordance with one or more aspects of the present disclosure. The communications manager 720 may be an example of aspects of a communications manager 520, a communications manager 620, or both, as described herein. The communications manager 720, or various components thereof, may be an example of means for performing various aspects of communication scheduling for reduced throughput in wideband as described herein. For example, the communications manager 720 may include a scheduling component 725, a transmission component 730, a DCI field component 735, a capability component 740, a scaling factor component 745, a TDRA table component 750, a processing component 755, a feedback component 760, a slot offset component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The scheduling component 725 is capable of, configured to, or operable to support a means for receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE. The transmission component 730 is capable of, configured to, or operable to support a means for receiving, based on the DCI message, the at least one transmission, where the at least one transmission is processed in accordance with the first threshold throughput.

In some examples, the DCI message is indicative that the two or more transmissions are to be processed in accordance with the first threshold throughput.

In some examples, to support receiving the DCI message, the DCI field component 735 is capable of, configured to, or operable to support a means for receiving, in the DCI message, one or more DCI fields indicative that the at least one transmission is to be processed in accordance with the first threshold throughput.

In some examples, the one or more DCI fields correspond to respective transport blocks of the two or more transmissions scheduled by the DCI message.

In some examples, the one or more DCI fields correspond to the two or more transmissions scheduled by the DCI message.

In some examples, the capability component 740 is capable of, configured to, or operable to support a means for transmitting a capability message indicative of a capability of the UE associated with processing. In some examples, the scaling factor component 745 is capable of, configured to, or operable to support a means for receiving control signaling, responsive to the capability message, that is indicative of a scaling factor, where the first threshold throughput is based on the scaling factor.

In some examples, to support receiving the DCI message, the TDRA table component 750 is capable of, configured to, or operable to support a means for receiving, in the DCI message, an indication of a row of a TDRA table at the UE, where the row of the TDRA table is indicative of the first threshold throughput and a slot offset between the DCI message and the at least one transmission of the two or more transmissions.

In some examples, the processing component 755 is capable of, configured to, or operable to support a means for determining to process the at least one transmission of the two or more transmissions in accordance with the first threshold throughput based on one or more gaps between respective resource allocations associated with the two or more transmissions.

In some examples, the feedback component 760 is capable of, configured to, or operable to support a means for transmitting one or more feedback messages indicative of whether the at least one transmission and one or more other transmissions of the two or more transmissions are successfully decoded by the UE, where: the at least one transmission and the one or more other transmissions are processed in accordance with the first threshold throughput, and the one or more feedback messages are transmitted via a same set of resources or respective sets of resources.

In some examples, the slot offset component 765 is capable of, configured to, or operable to support a means for receiving control signaling indicative of a first slot offset and a second slot offset, where: the first slot offset and the second slot offset each relate to respective durations of time between the DCI message and feedback messages associated with transmissions scheduled by the DCI message, the first slot offset is associated with the first threshold throughput, and the second slot offset is associated with the second threshold throughput.

In some examples, the feedback component 760 is capable of, configured to, or operable to support a means for transmitting first feedback in accordance with the first slot offset for one or more first transmissions of the two or more transmissions scheduled by the DCI message, where the one or more first transmissions are processed in accordance with the first threshold throughput. In some examples, the feedback component 760 is capable of, configured to, or operable to support a means for transmitting second feedback in accordance with the second slot offset for one or more second transmissions of the two or more transmissions scheduled by the DCI message, where the one or more second transmissions are processed in accordance with the second threshold throughput.

In some examples, the transmission component 730 is capable of, configured to, or operable to support a means for receiving the two or more transmissions scheduled by the DCI message in accordance with a beam mapping pattern, where the beam mapping pattern includes one of a cyclic beam mapping pattern or a periodic beam mapping pattern.

In some examples, the beam mapping pattern is based on the at least one transmission of the two or more transmissions being processed in accordance with the first threshold throughput.

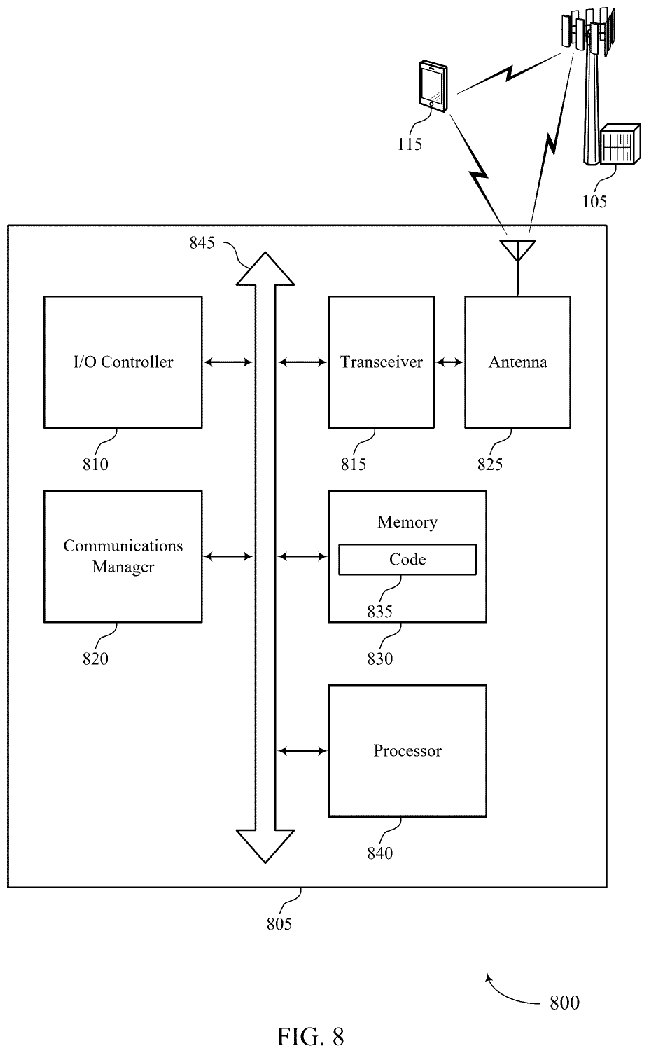

FIG. 8 shows a diagram of a system 800 including a device 805 that supports communication scheduling for reduced throughput in wideband in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting communication scheduling for reduced throughput in wideband). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE. The communications manager 820 is capable of, configured to, or operable to support a means for receiving, based on the DCI message, the at least one transmission, where the at least one transmission is processed in accordance with the first threshold throughput.

By including or configuring the communications manager 820 in accordance with examples as described herein, the device 805 may support techniques for reduced power consumption, more efficient utilization of communication resources, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of communication scheduling for reduced throughput in wideband as described herein, or the at least one processor 840 and the at least one memory 830 may be otherwise configured to, individually or collectively, perform or support such operations.

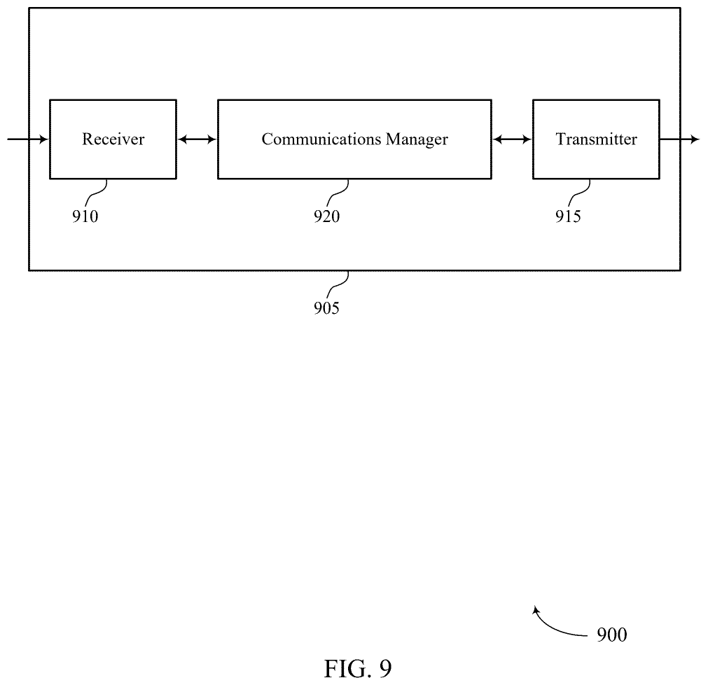

FIG. 9 shows a block diagram 900 of a device 905 that supports communication scheduling for reduced throughput in wideband in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of communication scheduling for reduced throughput in wideband as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE. The communications manager 920 is capable of, configured to, or operable to support a means for outputting, based on the DCI message, the two or more transmissions.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

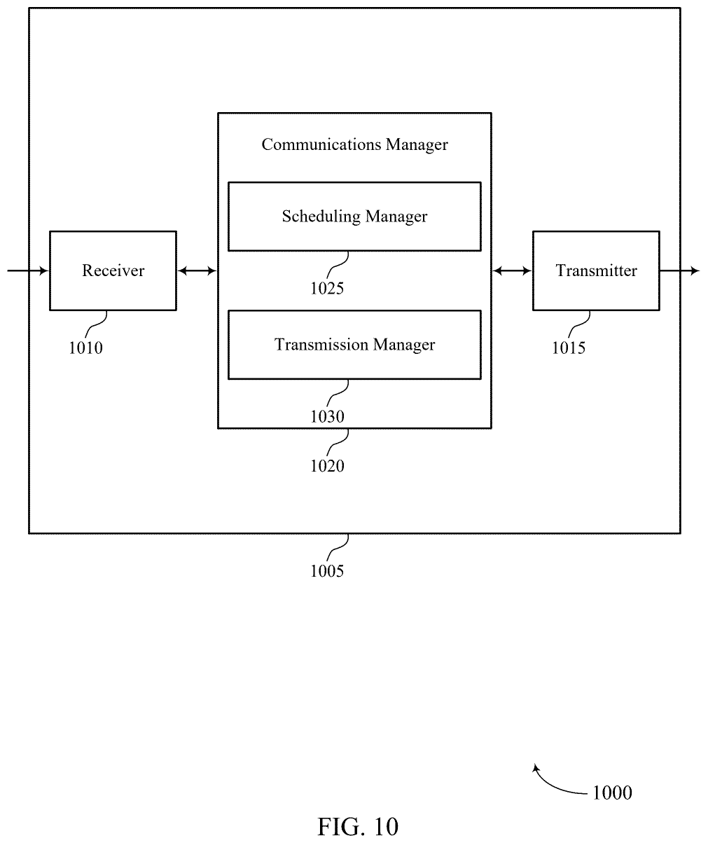

FIG. 10 shows a block diagram 1000 of a device 1005 that supports communication scheduling for reduced throughput in wideband in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of communication scheduling for reduced throughput in wideband as described herein. For example, the communications manager 1020 may include a scheduling manager 1025 a transmission manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The scheduling manager 1025 is capable of, configured to, or operable to support a means for outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE. The transmission manager 1030 is capable of, configured to, or operable to support a means for outputting, based on the DCI message, the two or more transmissions.

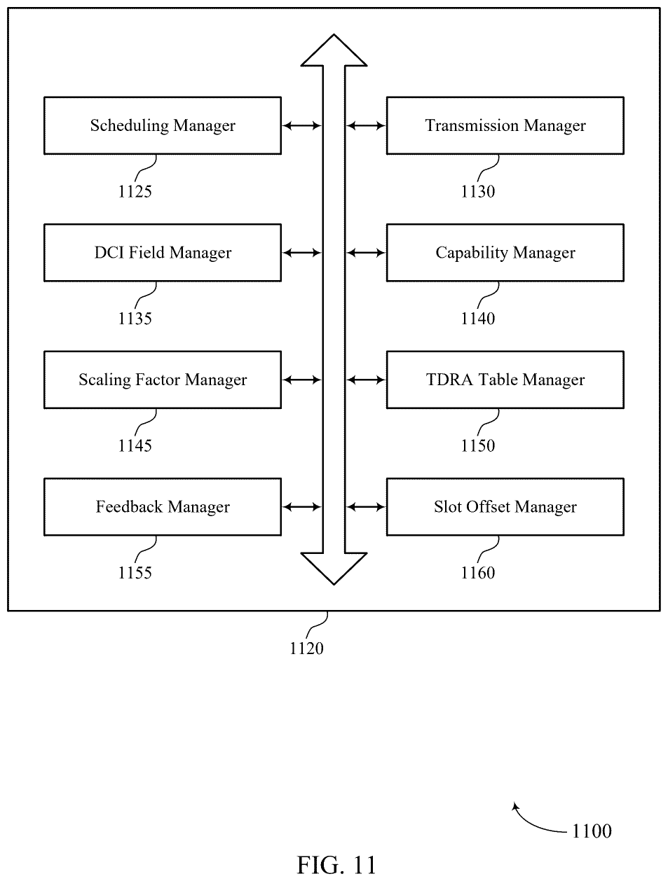

FIG. 11 shows a block diagram 1100 of a communications manager 1120 that supports communication scheduling for reduced throughput in wideband in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of communication scheduling for reduced throughput in wideband as described herein. For example, the communications manager 1120 may include a scheduling manager 1125, a transmission manager 1130, a DCI field manager 1135, a capability manager 1140, a scaling factor manager 1145, a TDRA table manager 1150, a feedback manager 1155, a slot offset manager 1160, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The scheduling manager 1125 is capable of, configured to, or operable to support a means for outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE. The transmission manager 1130 is capable of, configured to, or operable to support a means for outputting, based on the DCI message, the two or more transmissions.

In some examples, the DCI message is indicative that the two or more transmissions are to be processed in accordance with the first threshold throughput.

In some examples, to support outputting the DCI message, the DCI field manager 1135 is capable of, configured to, or operable to support a means for outputting, in the DCI message, one or more DCI fields indicative that the at least one transmission is to be processed in accordance with the first threshold throughput.

In some examples, the one or more DCI fields correspond to respective transport blocks of the two or more transmissions scheduled by the DCI message.

In some examples, the one or more DCI fields correspond to the two or more transmissions scheduled by the DCI message.

In some examples, the capability manager 1140 is capable of, configured to, or operable to support a means for obtaining a capability message indicative of a capability of the UE associated with processing. In some examples, the scaling factor manager 1145 is capable of, configured to, or operable to support a means for outputting control signaling, responsive to the capability message, that is indicative of a scaling factor, where the first threshold throughput is based on the scaling factor.

In some examples, to support outputting the DCI message, the TDRA table manager 1150 is capable of, configured to, or operable to support a means for outputting, in the DCI message, an indication of a row of a TDRA table at the UE, where the row of the TDRA table is indicative of the first threshold throughput and a slot offset between the DCI message and the at least one transmission of the two or more transmissions.

In some examples, the feedback manager 1155 is capable of, configured to, or operable to support a means for obtaining one or more feedback messages indicative of whether the at least one transmission and one or more other transmissions of the two or more transmissions are successfully decoded by the UE, where: the at least one transmission and the one or more other transmissions are processed in accordance with the first threshold throughput, and the one or more feedback messages are transmitted via a same set of resources or respective sets of resources.

In some examples, the slot offset manager 1160 is capable of, configured to, or operable to support a means for outputting control signaling indicative of a first slot offset and a second slot offset, where: the first slot offset and the second slot offset each relate to respective durations of time between the DCI message and feedback messages associated with transmissions scheduled by the DCI message, the first slot offset is associated with the first threshold throughput, and the second slot offset is associated with the second threshold throughput.

In some examples, the feedback manager 1155 is capable of, configured to, or operable to support a means for obtaining first feedback in accordance with the first slot offset for one or more first transmissions of the two or more transmissions scheduled by the DCI message, where the one or more first transmissions are processed in accordance with the first threshold throughput. In some examples, the feedback manager 1155 is capable of, configured to, or operable to support a means for obtaining second feedback in accordance with the second slot offset for one or more second transmissions of the two or more transmissions scheduled by the DCI message, where the one or more second transmissions are processed in accordance with the second threshold throughput.

In some examples, the transmission manager 1130 is capable of, configured to, or operable to support a means for outputting the two or more transmissions scheduled by the DCI message in accordance with a beam mapping pattern, where the beam mapping pattern includes one of a cyclic beam mapping pattern or a periodic beam mapping pattern.

In some examples, the beam mapping pattern is based on the at least one transmission of the two or more transmissions being processed in accordance with the first threshold throughput.

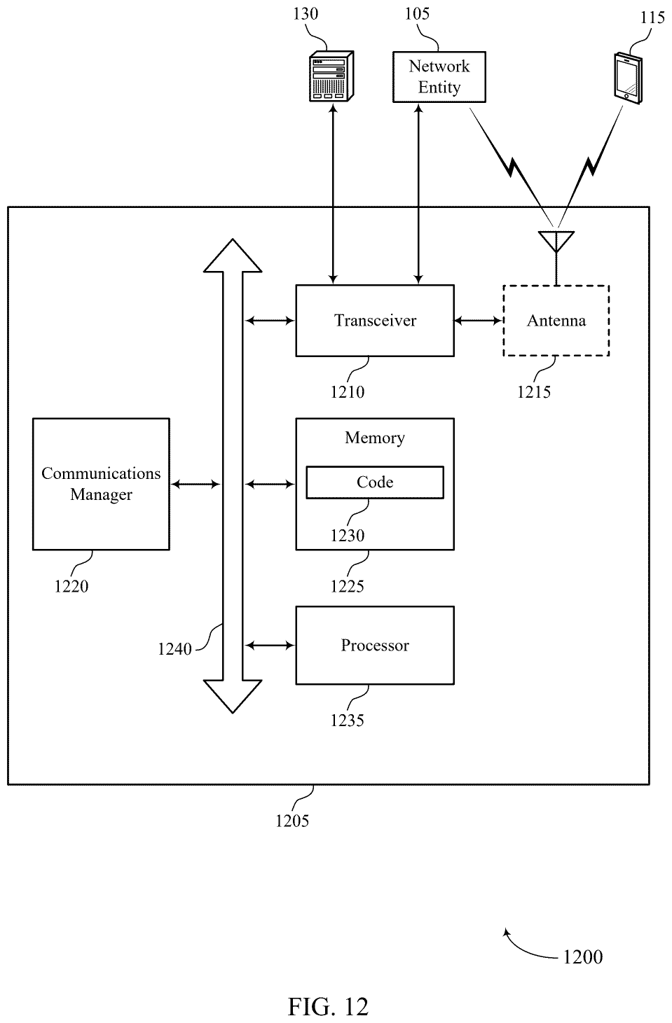

FIG. 12 shows a diagram of a system 1200 including a device 1205 that supports communication scheduling for reduced throughput in wideband in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting communication scheduling for reduced throughput in wideband). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE. The communications manager 1220 is capable of, configured to, or operable to support a means for outputting, based on the DCI message, the two or more transmissions.

By including or configuring the communications manager 1220 in accordance with examples as described herein, the device 1205 may support techniques for reduced power consumption, more efficient utilization of communication resources, and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of communication scheduling for reduced throughput in wideband as described herein, or the at least one processor 1235 and the at least one memory 1225 may be otherwise configured to, individually or collectively, perform or support such operations.

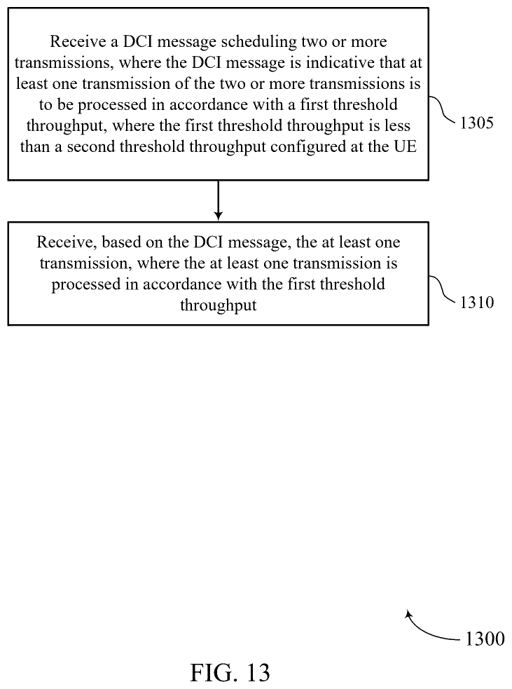

FIG. 13 shows a flowchart illustrating a method 1300 that supports communication scheduling for reduced throughput in wideband in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE. The operations of 1305 may be performed in accordance with examples as disclosed herein. In some examples, aspects of the operations of 1305 may be performed by a scheduling component 725 as described with reference to FIG. 7.

At 1310, the method may include receiving, based on the DCI message, the at least one transmission, where the at least one transmission is processed in accordance with the first threshold throughput. The operations of 1310 may be performed in accordance with examples as disclosed herein. In some examples, aspects of the operations of 1310 may be performed by a transmission component 730 as described with reference to FIG. 7.

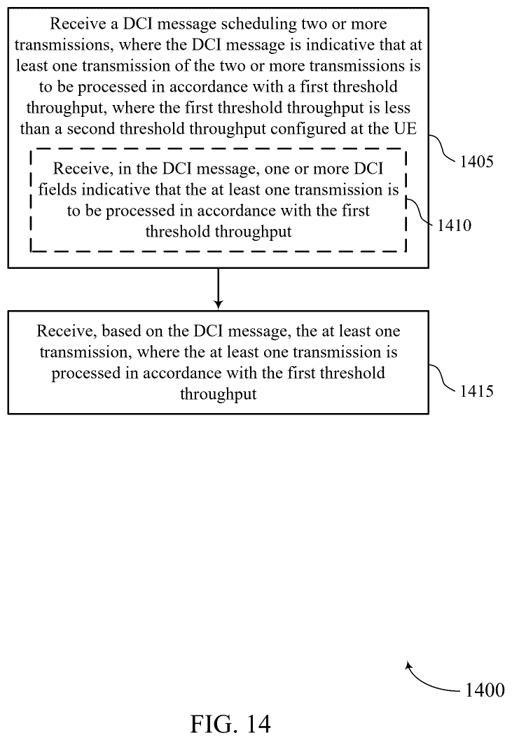

FIG. 14 shows a flowchart illustrating a method 1400 that supports communication scheduling for reduced throughput in wideband in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a DCI message scheduling two or more transmissions, where the DCI message is indicative that at least one transmission of the two or more transmissions is to be processed in accordance with a first threshold throughput, where the first threshold throughput is less than a second threshold throughput configured at the UE. The operations of 1405 may be performed in accordance with examples as disclosed herein. In some examples, aspects of the operations of 1405 may be performed by a scheduling component 725 as described with reference to FIG. 7.

At 1410, the method may include receiving, in the DCI message, one or more DCI fields indicative that the at least one transmission is to be processed in accordance with the first threshold throughput. The operations of 1410 may be performed in accordance with examples as disclosed herein. In some examples, aspects of the operations of 1410 may be performed by a DCI field component 735 as described with reference to FIG. 7.

At 1415, the method may include receiving, based on the DCI message, the at least one transmission, where the at least one transmission is processed in accordance with the first threshold throughput. The operations of 1415 may be performed in accordance with examples as disclosed herein. In some examples, aspects of the operations of 1415 may be performed by a transmission component 730 as described with reference to FIG. 7.

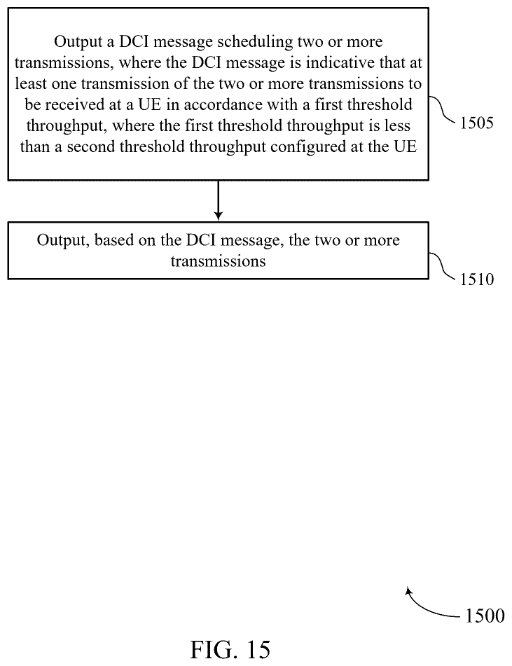

FIG. 15 shows a flowchart illustrating a method 1500 that supports communication scheduling for reduced throughput in wideband in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE. The operations of 1505 may be performed in accordance with examples as disclosed herein. In some examples, aspects of the operations of 1505 may be performed by a scheduling manager 1125 as described with reference to FIG. 11.

At 1510, the method may include outputting, based on the DCI message, the two or more transmissions. The operations of 1510 may be performed in accordance with examples as disclosed herein. In some examples, aspects of the operations of 1510 may be performed by a transmission manager 1130 as described with reference to FIG. 11.

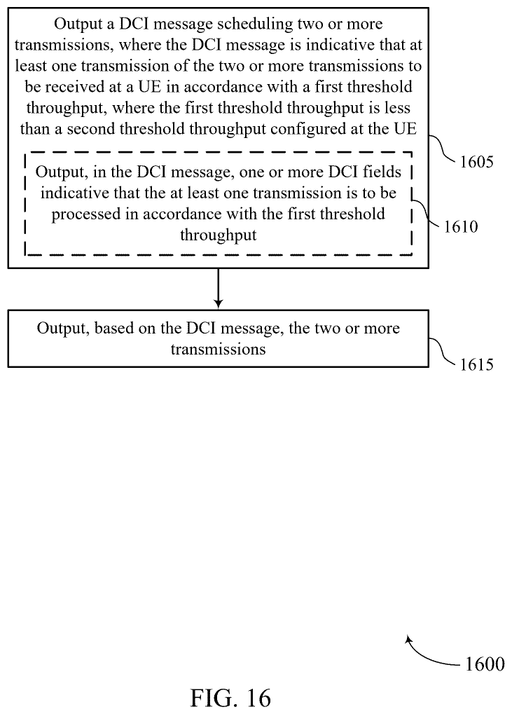

FIG. 16 shows a flowchart illustrating a method 1600 that supports communication scheduling for reduced throughput in wideband in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting a DCI message scheduling two or more transmissions, where the DCI message is indicative that at least one transmission of the two or more transmissions to be received at a UE in accordance with a first threshold throughput, where the first threshold throughput is less than a second threshold throughput configured at the UE. The operations of 1605 may be performed in accordance with examples as disclosed herein. In some examples, aspects of the operations of 1605 may be performed by a scheduling manager 1125 as described with reference to FIG. 11.

At 1610, the method may include outputting, in the DCI message, one or more DCI fields indicative that the at least one transmission is to be processed in accordance with the first threshold throughput. The operations of 1610 may be performed in accordance with examples as disclosed herein. In some examples, aspects of the operations of 1610 may be performed by a DCI field manager 1135 as described with reference to FIG. 11.

At 1615, the method may include outputting, based on the DCI message, the two or more transmissions. The operations of 1615 may be performed in accordance with examples as disclosed herein. In some examples, aspects of the operations of 1615 may be performed by a transmission manager 1130 as described with reference to FIG. 11.

The following provides an overview of aspects of the present disclosure:

Aspect 1: A method for wireless communications at a UE, comprising: receiving a DCI message scheduling two or more transmissions, wherein the DCI message is indicative that at least one transmission of the two or more transmissions is to be processed in accordance with a first threshold throughput, wherein the first threshold throughput is less than a second threshold throughput configured at the UE; and receiving, based at least in part on the DCI message, the at least one transmission, wherein the at least one transmission is processed in accordance with the first threshold throughput.

Aspect 2: The method of aspect 1, wherein the DCI message is indicative that the two or more transmissions are to be processed in accordance with the first threshold throughput.

Aspect 3: The method of any of aspects 1 through 2, wherein receiving the DCI message comprises: receiving, in the DCI message, one or more DCI fields indicative that the at least one transmission is to be processed in accordance with the first threshold throughput.

Aspect 4: The method of aspect 3, wherein the one or more DCI fields correspond to respective transport blocks of the two or more transmissions scheduled by the DCI message.

Aspect 5: The method of any of aspects 3 through 4, wherein the one or more DCI fields correspond to the two or more transmissions scheduled by the DCI message.

Aspect 6: The method of any of aspects 1 through 5, further comprising: transmitting a capability message indicative of a capability of the UE associated with processing; and receiving control signaling, responsive to the capability message, that is indicative of a scaling factor, wherein the first threshold throughput is based at least in part on the scaling factor.

Aspect 7: The method of any of aspects 1 through 6, wherein receiving the DCI message comprises: receiving, in the DCI message, an indication of a row of a TDRA table at the UE, wherein the row of the TDRA table is indicative of the first threshold throughput and a slot offset between the DCI message and the at least one transmission of the two or more transmissions.

Aspect 8: The method of any of aspects 1 through 7, further comprising: determining to process the at least one transmission of the two or more transmissions in accordance with the first threshold throughput based at least in part on one or more gaps between respective resource allocations associated with the two or more transmissions.

Aspect 9: The method of any of aspects 1 through 8, further comprising: transmitting one or more feedback messages indicative of whether the at least one transmission and one or more other transmissions of the two or more transmissions are successfully decoded by the UE, wherein: the at least one transmission and the one or more other transmissions are processed in accordance with the first threshold throughput, and the one or more feedback messages are transmitted via a same set of resources or respective sets of resources.

Aspect 10: The method of any of aspects 1 through 9, further comprising: receiving control signaling indicative of a first slot offset and a second slot offset, wherein: the first slot offset and the second slot offset each relate to respective durations of time between the DCI message and feedback messages associated with transmissions scheduled by the DCI message, the first slot offset is associated with the first threshold throughput, and the second slot offset is associated with the second threshold throughput.

Aspect 11: The method of aspect 10, further comprising: transmitting first feedback in accordance with the first slot offset for one or more first transmissions of the two or more transmissions scheduled by the DCI message, wherein the one or more first transmissions are processed in accordance with the first threshold throughput; and transmitting second feedback in accordance with the second slot offset for one or more second transmissions of the two or more transmissions scheduled by the DCI message, wherein the one or more second transmissions are processed in accordance with the second threshold throughput.

Aspect 12: The method of any of aspects 1 through 11, further comprising: receiving the two or more transmissions scheduled by the DCI message in accordance with a beam mapping pattern, wherein the beam mapping pattern comprises one of a cyclic beam mapping pattern or a periodic beam mapping pattern.

Aspect 13: The method of aspect 12, wherein the beam mapping pattern is based at least in part on the at least one transmission of the two or more transmissions being processed in accordance with the first threshold throughput.

Aspect 14: A method for wireless communications at a network entity, comprising: outputting a DCI message scheduling two or more transmissions, wherein the DCI message is indicative that at least one transmission of the two or more transmissions to be received at a UE in accordance with a first threshold throughput, wherein the first threshold throughput is less than a second threshold throughput configured at the UE; and outputting, based at least in part on the DCI message, the two or more transmissions.

Aspect 15: The method of aspect 14, wherein the DCI message is indicative that the two or more transmissions are to be processed in accordance with the first threshold throughput.

Aspect 16: The method of any of aspects 14 through 15, wherein outputting the DCI message comprises: outputting, in the DCI message, one or more DCI fields indicative that the at least one transmission is to be processed in accordance with the first threshold throughput.

Aspect 17: The method of aspect 16, wherein the one or more DCI fields correspond to respective transport blocks of the two or more transmissions scheduled by the DCI message.

Aspect 18: The method of any of aspects 16 through 17, wherein the one or more DCI fields correspond to the two or more transmissions scheduled by the DCI message.

Aspect 19: The method of any of aspects 14 through 18, further comprising: obtaining a capability message indicative of a capability of the UE associated with processing; and outputting control signaling, responsive to the capability message, that is indicative of a scaling factor, wherein the first threshold throughput is based at least in part on the scaling factor.

Aspect 20: The method of any of aspects 14 through 19, wherein outputting the DCI message comprises: outputting, in the DCI message, an indication of a row of a TDRA table at the UE, wherein the row of the TDRA table is indicative of the first threshold throughput and a slot offset between the DCI message and the at least one transmission of the two or more transmissions.

Aspect 21: The method of any of aspects 14 through 20, further comprising: obtaining one or more feedback messages indicative of whether the at least one transmission and one or more other transmissions of the two or more transmissions are successfully decoded by the UE, wherein: the at least one transmission and the one or more other transmissions are processed in accordance with the first threshold throughput, and the one or more feedback messages are transmitted via a same set of resources or respective sets of resources.

Aspect 22: The method of any of aspects 14 through 21, further comprising: outputting control signaling indicative of a first slot offset and a second slot offset, wherein: the first slot offset and the second slot offset each relate to respective durations of time between the DCI message and feedback messages associated with transmissions scheduled by the DCI message, the first slot offset is associated with the first threshold throughput, and the second slot offset is associated with the second threshold throughput.

Aspect 23: The method of aspect 22, further comprising: obtaining first feedback in accordance with the first slot offset for one or more first transmissions of the two or more transmissions scheduled by the DCI message, wherein the one or more first transmissions are processed in accordance with the first threshold throughput; and obtaining second feedback in accordance with the second slot offset for one or more second transmissions of the two or more transmissions scheduled by the DCI message, wherein the one or more second transmissions are processed in accordance with the second threshold throughput.

Aspect 24: The method of any of aspects 14 through 23, further comprising: outputting the two or more transmissions scheduled by the DCI message in accordance with a beam mapping pattern, wherein the beam mapping pattern comprises one of a cyclic beam mapping pattern or a periodic beam mapping pattern.

Aspect 25: The method of aspect 24, wherein the beam mapping pattern is based at least in part on the at least one transmission of the two or more transmissions being processed in accordance with the first threshold throughput.

Aspect 26: A UE for wireless communications, comprising one or more memories storing processor-executable code, and one or more processors coupled with the one or more memories and individually or collectively operable to execute the code to cause the UE to perform a method of any of aspects 1 through 13.

Aspect 27: A UE for wireless communications, comprising at least one means for performing a method of any of aspects 1 through 13.

Aspect 28: A non-transitory computer-readable medium storing code for wireless communications, the code comprising instructions executable by one or more processors to perform a method of any of aspects 1 through 13.

Aspect 29: A network entity for wireless communications, comprising one or more memories storing processor-executable code, and one or more processors coupled with the one or more memories and individually or collectively operable to execute the code to cause the network entity to perform a method of any of aspects 14 through 25.

Aspect 30: A network entity for wireless communications, comprising at least one means for performing a method of any of aspects 14 through 25.

Aspect 31: A non-transitory computer-readable medium storing code for wireless communications, the code comprising instructions executable by one or more processors to perform a method of any of aspects 14 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.c., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed hercin.

What is claimed is:

1. A user equipment (UE), comprising:
one or more memories storing processor-executable code; and
one or more processors coupled with the one or more memories and individually or collectively operable to execute the code to cause the UE to:
receive a downlink control information message scheduling two or more transmissions, wherein the downlink control information message is indicative that at least one transmission of the two or more transmissions is to be processed in accordance with a first threshold throughput, wherein the first threshold throughput is less than a second threshold throughput configured at the UE; and
receive, based at least in part on the downlink control information message, the at least one transmission, wherein the at least one transmission is processed in accordance with the first threshold throughput.

2. The UE of claim 1, wherein the downlink control information message is indicative that the two or more transmissions are to be processed in accordance with the first threshold throughput.

3. The UE of claim 1, wherein, to receive the downlink control information message, the one or more processors are individually or collectively operable to execute the code to cause the UE to:
receive, in the downlink control information message, one or more downlink control information fields indicative that the at least one transmission is to be processed in accordance with the first threshold throughput.

4. The UE of claim 3, wherein the one or more downlink control information fields correspond to respective transport blocks of the two or more transmissions scheduled by the downlink control information message.

5. The UE of claim 3, wherein the one or more downlink control information fields correspond to the two or more transmissions scheduled by the downlink control information message.

6. The UE of claim 1, wherein the one or more processors are individually or collectively further operable to execute the code to cause the UE to:
transmit a capability message indicative of a capability of the UE associated with processing; and
receive control signaling, responsive to the capability message, that is indicative of a scaling factor, wherein the first threshold throughput is based at least in part on the scaling factor.

7. The UE of claim 1, wherein, to receive the downlink control information message, the one or more processors are individually or collectively operable to execute the code to cause the UE to:
receive, in the downlink control information message, an indication of a row of a time domain resource allocation table at the UE, wherein the row of the time domain resource allocation table is indicative of the first threshold throughput and a slot offset between the downlink control information message and the at least one transmission of the two or more transmissions.

8. The UE of claim 1, wherein the one or more processors are individually or collectively further operable to execute the code to cause the UE to:
determine to process the at least one transmission of the two or more transmissions in accordance with the first threshold throughput based at least in part on one or more gaps between respective resource allocations associated with the two or more transmissions.

9. The UE of claim 1, wherein the one or more processors are individually or collectively further operable to execute the code to cause the UE to:
transmit one or more feedback messages indicative of whether the at least one transmission and one or more other transmissions of the two or more transmissions are successfully decoded by the UE, wherein:
the at least one transmission and the one or more other transmissions are processed in accordance with the first threshold throughput, and
the one or more feedback messages are transmitted via a same set of resources or respective sets of resources.

10. The UE of claim 1, wherein the one or more processors are individually or collectively further operable to execute the code to cause the UE to:
receive control signaling indicative of a first slot offset and a second slot offset, wherein:
the first slot offset and the second slot offset each relate to respective durations of time between the downlink control information message and feedback messages associated with transmissions scheduled by the downlink control information message,
the first slot offset is associated with the first threshold throughput, and
the second slot offset is associated with the second threshold throughput.

11. The UE of claim 10, wherein the one or more processors are individually or collectively further operable to execute the code to cause the UE to:
transmit first feedback in accordance with the first slot offset for one or more first transmissions of the two or more transmissions scheduled by the downlink control information message, wherein the one or more first transmissions are processed in accordance with the first threshold throughput; and
transmit second feedback in accordance with the second slot offset for one or more second transmissions of the two or more transmissions scheduled by the downlink control information message, wherein the one or more second transmissions are processed in accordance with the second threshold throughput.

12. The UE of claim 1, wherein the one or more processors are individually or collectively further operable to execute the code to cause the UE to:
receive the two or more transmissions scheduled by the downlink control information message in accordance with a beam mapping pattern, wherein the beam mapping pattern comprises one of a cyclic beam mapping pattern or a periodic beam mapping pattern.

13. The UE of claim 12, wherein the beam mapping pattern is based at least in part on the at least one transmission of the two or more transmissions being processed in accordance with the first threshold throughput.

14. A network entity, comprising:
one or more memories storing processor-executable code; and
one or more processors coupled with the one or more memories and individually or collectively operable to execute the code to cause the network entity to:
output a downlink control information message scheduling two or more transmissions, wherein the downlink control information message is indicative that at least one transmission of the two or more transmissions to be received at a user equipment (UE) in accordance with a first threshold throughput, wherein the first threshold throughput is less than a second threshold throughput configured at the UE; and
output, based at least in part on the downlink control information message, the two or more transmissions.

15. The network entity of claim 14, wherein the downlink control information message is indicative that the two or more transmissions are to be processed in accordance with the first threshold throughput.

16. The network entity of claim 14, wherein, to output the downlink control information message, the one or more processors are individually or collectively operable to execute the code to cause the network entity to:
output, in the downlink control information message, one or more downlink control information fields indicative that the at least one transmission is to be processed in accordance with the first threshold throughput.

17. The network entity of claim 16, wherein the one or more downlink control information fields correspond to respective transport blocks of the two or more transmissions scheduled by the downlink control information message.

18. The network entity of claim 16, wherein the one or more downlink control information fields correspond to the two or more transmissions scheduled by the downlink control information message.

19. The network entity of claim 14, wherein the one or more processors are individually or collectively further operable to execute the code to cause the network entity to:
obtain a capability message indicative of a capability of the UE associated with processing; and
output control signaling, responsive to the capability message, that is indicative of a scaling factor, wherein the first threshold throughput is based at least in part on the scaling factor.

20. The network entity of claim 14, wherein, to output the downlink control information message, the one or more processors are individually or collectively operable to execute the code to cause the network entity to:
output, in the downlink control information message, an indication of a row of a time domain resource allocation table at the UE, wherein the row of the time domain resource allocation table is indicative of the first threshold throughput and a slot offset between the downlink control information message and the at least one transmission of the two or more transmissions.

21. The network entity of claim 14, wherein the one or more processors are individually or collectively further operable to execute the code to cause the network entity to:
obtain one or more feedback messages indicative of whether the at least one transmission and one or more other transmissions of the two or more transmissions are successfully decoded by the UE, wherein:
the at least one transmission and the one or more other transmissions are processed in accordance with the first threshold throughput, and
the one or more feedback messages are transmitted via a same set of resources or respective sets of resources.

22. The network entity of claim 14, wherein the one or more processors are individually or collectively further operable to execute the code to cause the network entity to:
output control signaling indicative of a first slot offset and a second slot offset, wherein:
the first slot offset and the second slot offset each relate to respective durations of time between the downlink control information message and feedback messages associated with transmissions scheduled by the downlink control information message,
the first slot offset is associated with the first threshold throughput, and
the second slot offset is associated with the second threshold throughput.

23. The network entity of claim 22, wherein the one or more processors are individually or collectively further operable to execute the code to cause the network entity to:
obtain first feedback in accordance with the first slot offset for one or more first transmissions of the two or more transmissions scheduled by the downlink control information message, wherein the one or more first transmissions are processed in accordance with the first threshold throughput; and
obtain second feedback in accordance with the second slot offset for one or more second transmissions of the two or more transmissions scheduled by the downlink control information message, wherein the one or more second transmissions are processed in accordance with the second threshold throughput.

24. The network entity of claim 14, wherein the one or more processors are individually or collectively further operable to execute the code to cause the network entity to:
output the two or more transmissions scheduled by the downlink control information message in accordance with a beam mapping pattern, wherein the beam mapping pattern comprises one of a cyclic beam mapping pattern or a periodic beam mapping pattern.

25. The network entity of claim 24, wherein the beam mapping pattern is based at least in part on the at least one transmission of the two or more transmissions being processed in accordance with the first threshold throughput.

26. A method for wireless communications at a user equipment (UE), comprising:
receiving a downlink control information message scheduling two or more transmissions, wherein the downlink control information message is indicative that at least one transmission of the two or more transmissions is to be processed in accordance with a first threshold throughput, wherein the first threshold throughput is less than a second threshold throughput configured at the UE; and
receiving, based at least in part on the downlink control information message, the at least one transmission, wherein the at least one transmission is processed in accordance with the first threshold throughput.

27. The method of claim 26, wherein the downlink control information message is indicative that the two or more transmissions are to be processed in accordance with the first threshold throughput.

28. The method of claim 26, wherein receiving the downlink control information message comprises:
receiving, in the downlink control information message, one or more downlink control information fields indicative that the at least one transmission is to be processed in accordance with the first threshold throughput.

29. A method for wireless communications at a network entity, comprising:
outputting a downlink control information message scheduling two or more transmissions, wherein the downlink control information message is indicative that at least one transmission of the two or more transmissions to be received at a user equipment (UE) in accordance with a first threshold throughput, wherein the first threshold throughput is less than a second threshold throughput configured at the UE; and
outputting, based at least in part on the downlink control information message, the two or more transmissions.

30. The method of claim 29, wherein the downlink control information message is indicative that the two or more transmissions are to be processed in accordance with the first threshold throughput.
